(19) United States
(12) Patent Application Publication
(10) Pub. No.: US 2008/0270581 A1
(43) Pub. Date: Oct. 30, 2008

(54) Communication management tools for a secure information sharing architecture to facilitate post merger integration

(75) Inventors: Kristin L. Ficery, Atlanta, GA (US); Meng Yen Ti, Bagio Villa (HK); Karen Lindgren, Chicago, IL (US); David Goldson, Livingston, NJ (US); Michael J. Russell, Atlanta, GA (US); Andrew Zimmerman, New York, NY (US); Tera McCallum, Rantown, MO (US); P. Christopher Bosco, Overland Park, KS (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 11/797,080

(22) Filed: Apr. 30, 2007

(51) Int. Cl. G06F 15/177

(52) U.S. Cl. 709/220

(57) ABSTRACT

Disclosed herein are architectures and related processes and communication tools for enabling secure information sharing and post-merger integration planning during the regulatory review period of mergers and acquisitions. The disclosed embodiments include a secure information sharing architecture and related communication processes and tools for facilitating data flow from companies involved in a merger transaction into a quarantined center of a secure information sharing architecture while ensuring that information integrity is maintained in compliance with regulatory restrictions, and automated tools for allowing users to track and view the status of communications into and out of the quarantined center.

### FIELD OF THE INVENTION

The present invention relates to an architecture and its related processes and communication tools for enabling secure information sharing and post-merger integration planning during the regulatory review period of mergers and acquisitions. More particularly, the present invention pertains to a secure information sharing architecture and related communication processes and tools for facilitating data flow from companies involved in a merger transaction into a quarantined center of a secure information sharing architecture while ensuring that information integrity is maintained in compliance with regulatory restrictions.

### BACKGROUND OF THE INVENTION

Mergers are common characteristics of our modern market economies dominated by corporations and other large companies. Companies continuously are trying to maintain or enhance profitability, and one mechanism for doing so is finding synergies that can be obtained from other companies. Advantageous economies of scale, vertical integration with suppliers and distributors, or horizontal integration with entities competing in or providing complementary goods or services to the same market are all examples of the types of synergies that can be established. Business and corporate mergers and acquisitions are frequent occurrences in many markets and industries exactly because they are seen as mechanisms for obtaining synergies relatively quickly and safely. Currently, mergers are becoming more and more complex with the involved companies often being large and diverse, and potentially leveraging much of their fiscal health and growth upon the success of the merger.

While success of the merger is of paramount importance to both companies, it also remains important for merger activities to be segregated from day to day activities of both companies involved. First, the merger cannot become an ongoing distraction in daily operations for the two companies. Second, regulatory restrictions imposed by the U.S. Securities and Exchange Commission (“SEC”) requires mergers to be submitted for approval. Pending such approval, certain restrictions apply, including a bar on any potentially anti-competitive collaboration between the merging companies. The Hart-Scott-Rodino Act in particular prohibits the sharing of information between merging entities until the deal has gained regulatory approval and is officially closed. Further, for mergers of extremely large scale, regulatory approval is not only required from the SEC but also the U.S. Department of Justice to resolve any concerns with respect to the antitrust laws. Such approvals must be obtained before the merger is allowed to proceed, thus generally delaying the post-merger activities of the companies.

Generally, merger transactions can be conceptualized as evolving according to a typical lifecycle that includes various overlapping but distinguishable pre-deal phases and post-deal phases. An example of a post-deal portion of a merger transaction lifecycle timeline 100 is depicted in FIG. 1. As shown in the drawing, immediately following the announcement 105 of the deal, the post-deal phases 101-104 begin. The first post-deal phase includes the establishing of the merger architecture 101, wherein the high level managers of the merging companies make critical decisions regarding the business case for the merger, including what synergies to target for exploitation and general decisions on integration direction. This phase 101 is very early after the deal has been made and typically does not last very long. The next phase typically begins with the establishing of a merger integration team at 106, which team is comprised of select managers from the acquirer company, and sometimes hired third parties and possibly a few select members of the acquirer company. This phase comprises more detailed pre-approval planning 102, wherein the merger integration team works on setting priorities and work plans for the integration and, to the extent possible given regulatory restrictions, attempts to make critical decisions that are required for the eventual integration of the two companies. Importantly, it is during the pre-merger planning phase 102 that the lengthy regulatory approval process 109 generally is begun.

When regulatory permission is obtained, the deal closing process 110 can finally begin, signaling the commencement of the design integration post-deal phase 103 of the post-deal timeline portion 100. This phase 103 commonly includes a flurry of kick-off decision making activities, typically performed by a dedicated joint merger team 107 containing representatives from both companies. It is only once this phase begins (i.e., following closing of the deal 110) that the merging companies will be able to collaboratively design the internal processes for integrating the two businesses.

Finally, once strategic decisions have been made collaboratively, the actual acts of integrating the two business can occur in the rationalize and optimize phase 104. At some point during this phase, the new business entity will be able to launch integrated business activities 108 to implement changes and capture the savings and value desired from the merger transaction in the first place.

Therefore, as demonstrated in FIG. 1, regulatory delays push back important post merger integration activities. Oftentimes, pending regulatory approval, all key preparations for the post merger integration and consolidation must be made at arms length between the two companies. Thus, strategic planning is not possible during the merger review period because sharing detailed, competitively-sensitive information is not allowed under law. Attempts to circumvent these regulatory requirements raises significant risks of illegal pre-merger coordination, which could result in potential criminal prosecution or heavy fines. This puts companies undergoing a merger into difficult situations. On the one hand, they cannot assume the merger will be approved at all, let alone without requiring certain divestitures or other changes to the terms submitted for approval. On the other hand, once the merger deal is announced, the two companies cannot proceed without making preparations for life after the deal. The issue thus remains that managers must be equipped with the best methods, mechanisms, and support tools for making arms-length preparations for post-merger integration.

Many businesses turn to external consulting firms or other specialists to evaluate proposed merger and to manage the transition period for an ongoing merger. Various differing developments must take place in a relatively short time period within the merger integration period for a merger to proceed successfully, including the merging of organizations, cultures, and technologies, to eliminate redundant resources, retain the best elements from each of the original companies, and establish new elements needed by the resulting merged company. The primary advantage that an experienced consulting firm or other organization of specialists enjoys are the pooled resources and past experiences of various persons within the firm with regard to these merger related changes. While one or more of the managers of the merging companies may have experience regarding a prior merger or two, the more experienced specialists may each have the benefit of working on more total mergers than the combined experiences of all the managers of the merging companies. Thus, specialist firms are able to capitalize upon their wider scope of past experience and specific knowledge regarding the lifecycle of mergers, utilizing knowledge of commonly encountered problems and pitfalls, guideposts for tracking progress, and ways to solve problems and avoid pitfalls to more efficiently direct the merging companies to meet the ultimate business objectives underlying the merger.

While specialists can be hired at the pre-deal stage (i.e., during negotiations or prior to a deal being announced publicly), typically specialists are hired into a post-merger integration situation after the announcement of the deal to manage a merger after the companies have already signed contracts and announced the merger, and sometimes even after closing when various post-merger integration steps have already been taken. Most experts, however, agree that the period from the time a merger deal is announced through the first 12 to 24 months of post-merger integration is critical. Unfortunately, the time from announcement to closing of the deal, due to various regulatory reviews on the national and international levels, can be ten months or more. For certain deals, intense shareholder scrutiny can further increase the time from announcement to closure.

Furthermore, a business organization often desires to merge with or acquire a target company in part because of a particular desire to obtain the benefits of any series or set of assets, skills or capabilities of the target that will be relevant to their post-transition business. Yet, because of the current regulatory scheme, it is likely that significant time will pass before the acquirer business will be able to integrate the operations or structure of the target business organization to an extent sufficient to permit the transforming business organization to experience appreciable benefits from the target element. Thus, the anti-collaboration restrictions imposed by the relevant laws and regulations greatly hamper the ability of managers to make effective use of this critical period for potentially valuable in-depth planning for post-merger integration.

Lead specialists typically enlist additional personnel resources from their organization, usually in the form of a team of less experienced specialists that will work under the direction of the lead specialist. These team members are often given the tasks of information gathering and sorting, such as by contacting and interviewing employees of one or more of the merging companies and obtaining, reviewing and organizing public records relevant to post-merger integration activities.

Data clean rooms are tools that have been used for decades as a means to collect and synthesize data from merging entities in a secure and legally compliant environment. In the traditional sense, a data clean room is a physical, secure location that is sealed off from the merging companies' business activities. It is restricted to authorized individuals so that they may handle sensitive data or information from the merging companies in a legally compliant manner. Traditional data clean rooms therefore were used as a mechanism in certain discrete circumstances to reduce the risks of running afoul of the information sharing regulations by walling sensitive business information off from regular business activities.

Typically, the personnel authorized to access a traditional clean room would be associated with a third-party to the merger transaction (e.g., consultancies, investment banks, law firms, accounting firms) and not from either of the merging entities. Use of the data clean room would be limited to the handling of all legitimate data requests from these third parties, so that they could analyze proprietary information of the pre-merger entities before regulatory approval is obtained and the merger is officially closed. In this regard, traditional data clean rooms conventionally are used in the period where the two companies are exploring and developing the deal (i.e., before announcing the deal to the public or shareholders, and before starting the regulatory approval process). “Due diligence” reviews undertaken by bankers or attorneys use the data clean rooms primarily for rendering opinions to one of the merging regarding the accuracy of the financial statements of the other merging company. Such conventional data clean rooms therefore utilize document repositories to centrally store documents and data collected from the pre-merger entities necessary for the due diligence process. They also many be maintained through regulatory review for the purpose of facilitating follow up due diligence reviews (if changes are made to the proposed deal), or to serve as an information source for regulatory reviewers.

Such due diligence reviews using traditional data rooms, however, are limited in purpose and use. Under conventional practices, they are not capable of helping the merging companies during the post-merger integration process to obtain the highest value from the merger. Rather, they are intended to do just the opposite—to act as a prophylactic for regulatory compliance by walling off the sensitive business information that could be used for effective, yet impermissible, collaborative planning.

Given the above-described information-sharing and other constraints imposed upon collaborative activities in the pre-closing phases, it is thus common for merging companies treat pre-closing and post-closing phases of a merger deal as discrete efforts. Sometimes, they even go so far as to use entirely different teams in the periods before and after the deal closing. This segregated approach results in vague accountability and general lack of leadership, unnecessary handoffs, and a disconnect between the valuation and the financial goals of the post-merger integration. In fact, this disconnect can be severe enough that post-merger integration teams tasked with managing synergy capture in the resulting merged entity could have little to no insight regarding what levels of synergy are necessary to recover the premiums that were paid in the acquisition deal. Understandably and unfortunately, this greatly reduces the chance that a successful deal will result.

Another factor negatively impacting the success of post-merger integration is that it is conventional for many companies to organize their post-merger integration activities on a function basis rather than on a value-added basis. While many function activities must be consolidated between the merging companies, such as, for example, merging databases, rationalizing corporate policies and procedures, reconfiguring information technology (“IT”) systems and the like, it should be clear that not all integration activities will yield equal benefits. Due to lack of experience in post-merger integration, unfortunately, companies do not always have an understanding regarding which integration activities will yield the most benefits, but nonetheless feel compelled to proceed aggressively in resolving merger integration issues. Such aggressive integration of various functions from the merging entities can actually result in destruction of value if value creation is not given appropriate consideration in integration planning. It would be most beneficial if important decisions (and subsequent execution of those decisions) could be made as early in the post-merger integration period as possible while still allowing integration issues to be strategically resolved, with certain decisions and integration activities being addressed and undertaken before others. Unfortunately, the current state of the art provides no mechanisms or tools to make this possible while ensuring regulatory compliance.

Furthermore, since speed of integration activities is very important, merging companies cannot merely proceed at a slow and deliberate pace to make certain that activities are thoroughly planned and initiated in the best order. Delays in the final integration into a merged entity can directly cost the merged entity millions of dollars per day. Indirect financial repercussions can also result from such delays, including postponed business strategy implementation, diminished employee morale, and workplace or customer defections that result from uncertainty. Unfortunately, the current state of the art provides no mechanisms and tools that can be used to facilitate and expedite merger integration planning within the restrictions set by the current regulatory scheme. Thus, the potential for benefits that could be reaped from early strategic planning for the resolution of post-merger integration issues remain largely unrealized.

Therefore, there is a need for improved mechanisms for transforming a business organization that does not suffer from the above mentioned problems. A mechanism that enables the merging entities to utilize the period prior to final regulatory approval provides for in-depth planning to achieve fast realization of high priority capabilities and goals for the new organization would be beneficial. Such mechanisms should enable representatives of the merging companies to use the regulatory approval and closing windows to perform in-depth research regarding high value or high priority in the upcoming post merger integration, develop action plans for those areas with suitable remedial or corrective actions to be taken to improve the situation of the merger in those areas, and to communicate with the merging entities to obtain guidance and information in support of these research and planning activities in a manner that does not risk running afoul of relevant anti-collaboration regulations.

### SUMMARY OF THE INVENTION

In light of the above-described and other problems associated with post merger integration, it is an object of one or more embodiments of the present invention to provide tools and mechanisms that enable merging companies to conduct extensive planning of post-merger integration activities without violating anti-collaboration restrictions during the regulatory review window.

Furthermore, it is an object of one or more embodiments of the present invention to provide architectures in conjunction with such tools that permit secure information sharing during the pre-closing period of the merger lifecycle by tracking information exchange between the merging entities to ensure compliance with legal requirements.

Also, it is an object of one or more embodiments of the present invention to provide methods that automatically track information exchange between various parties involved in post-merger integration planning during the pre-closing period in a manner sufficient to ensure prohibited collaboration does not occur until after merger approval and deal closing.

In response to these and other objects and needs, the various embodiments of the present invention as hereafter described provide a secure information sharing architecture and related processes and tools for facilitating data gathering, information organizing, and communication tracking during these gathering and organizing efforts so as to accelerate the post merger integration process for companies involved in a merger transaction while ensuring that information integrity is maintained in compliance with regulatory restrictions.

The present invention systemically accelerates value creation by providing an architecture that enables companies undergoing a merger or acquisition (generally, “merging business entities” or “merging entities”) to take full advantage of the typical “dead time” between deal announcement and closing, and to minimize the delay this dead time causes in jumpstarting the merger integration process. This approach according to the present invention entails the establishment of a secure information sharing architecture and the use of related processes and electronic tools that are employed between the time of merger announcement and merger finalization (approval and closing). The architecture and related processes and tools according to the present invention reduce the time required to implement merger integration-related changes, but also substantially mitigate underlying business risks in the merger deal.

Unlike the conventional data clean room approach, the secure information sharing architecture and related processes and tools of the present invention provide mechanisms that enable prospective business partners to initiate company comparisons and analyses and perform detailed strategic planning for the post-merger integration period during the early pre-merger period, thus significantly speeding up important post-merger integration planning timeframes. Instead of having to wait for formal approval and closing of the merger, the secure information sharing processes and electronic tools operate effectively within a computer network architecture of the present invention to permit detailed analyses to be performed regarding the prospective merger partners by qualified third parties, and separated from employees or executives of the merging companies, in a manner that satisfies the restrictions imposed by SEC regulations and other relevant regulations and laws.

In this regard, the various embodiments of the present invention establish a network architecture that supports various communication tracking and progress management tools for tracking synergies, assisting the legal teams with regulatory findings, setting up post-merger governance models, and administering the overall project calendar.

Thus, in the period from announcement to close, the specialists utilizing the secure information sharing architecture (“SISA”) according to embodiments of the present invention are provided with secure access to sensitive and confidential business information submitted by one or more of various merging entities within a secure SISA center. This SISA center may be a physical location or virtual location, and preferably both, supported by the tools and processes according to the invention, which tools enable the submitted information to be segregated from the various merging entities. Within the SISA center, specialists that are isolated from the merging entities (until such time that interaction is appropriate) are legally permitted to review the sensitive and confidential information submitted to the SISA center by the merging entities to examine key aspects of the new entity that would result from merger of the merging entities, and model those aspects against value-capture objectives and assigned priorities. The process can address integration issues in areas ranging from retail distribution to billing processes to advertising effectiveness so long as the rules established by the secure information sharing architecture are obeyed.

The tools according to the present invention permit benefits of the merger to be realized earlier into the post-merger integration period without raising risks that the merging entities will run afoul anti-competition prohibitions that apply prior to closing. Thus, utilizing the architectures according to embodiments of the present invention, it is possible for positive value creation to be realized at a relatively earlier time after post-merger or post acquisition integration activities are begun.

The SISA according to embodiments of the present invention employs a dual or mirrored organizational structure with a corresponding dual network architecture that permits two levels of post-merger planning to take place in parallel prior to final regulatory approval and closing while allowing only certain carefully monitored, tracked, and cataloged communications to occur between the two parts of the organizational structure. A first level of planning takes place outside of the SISA center and is driven by employees or contractors associated with one of the merging entities (typically, the acquirer), and proceeds in similar fashion to the conventional post-merger integration planning described above. The merging entity assigns these people to post merger integration planning tasks and/or associates them into one or more post merger integration planning teams under the control of a SISA management office. These “external” integration teams operate under the typical restraints imposed by the anti-collaboration SEC regulations. However, these integration planning tasks and “external” integration teams are mirrored within a quarantined SISA center by similar integration teams that operate substantially independently of the merging entities.

In this manner, while the external integration teams are prevented from conducting collaborative planning until regulatory approval is obtained and closing begins, the teams within the SISA center can operate in parallel using sensitive and confidential financial and operations information and data submitted by each merging entity and stored with a secure information repository of the SISA center. Thus, each of these parallel paths of integration activity have similar goals and work on similar integration tasks, but operate substantially independently until deal closing using different types of information so as to comply with all relevant regulatory requirements and restrictions. Therefore, upon merger approval and deal closing, the external and SISA center integration teams can launch directly into rapid post-merger integration activities using the plans and other outputs developed within the SISA center. Furthermore, should the deal not be approved or otherwise ultimately not proceed to closing, the information in and outputs produced within the SISA center can be destroyed to avoid any allegations of anti-competitive activities and associated liabilities.

Embodiments of the present invention utilize specification requests as a mechanism for managing how the SISA creates and delivers value to the post merger integration process. Given their quarantine according to the architecture and electronic platforms as described herein, specialists that work as personnel within the SISA center are freed of the constraints imposed by the SEC anti-collaboration window. In particular, the specification requests reflect specific requests made by the management of the merging companies for research into particular areas of post-merger integration with the goal of proactively determining how to best realize the objectives of the merger transaction before closing. The specification requests are used a basis for carefully tracking and controlling information flowing into and out of the SISA center to prevent unlawful collaboration while still permitting the specialists of the SISA personnel to review information that normally would be restricted for sharing during the anti-collaboration window.

Additionally, clarification requests are used in embodiments of the present invention where it is necessary for specialists who are SISA personnel to request guidance regarding the specification requests from outside personnel, such as external integration team members and/or management of one or both of the merging entities. In this regard, clarification requests containing clarifying questions, upon getting approval following legal review, can be sent out of the SISA center to the originator of the specification request (e.g., a management team for one of the merging entities) to resolve ambiguities.

Additionally, embodiments of the present invention utilize electronic platforms and related electronic tools for integrating communication systems of SISA center with the outside world, including the external integration teams and the merging entities themselves, via the SISA management office. In preferred embodiments of the present invention, an actual SISA center facility is located remotely from the pre-merger organization, and has a secure information facility electronic platform that is in electronic communication with one or more pre-merger organization front ends via a SISA management office electronic platform. The SISA management office in many embodiments of the invention will deal directly with only one of the two pre-merger organizations (e.g., the acquirer company). In such typical embodiments, there can be only one pre-merger organization front end that is accessible only by leadership of the acquirer organization. However, in alternative embodiments, a pre-merger organization front end can be provided for two or more of the pre-merger entities.

Each pre-merger organization front end is in communication with the SISA management office computing platform via a SISA management office component of a secure communication tracking and progress management tool. This SISA management office component in turn is in communication with a second component of the secure communication tracking and progress management tool that runs within the electronic platform of the SISA center facility. Each pre-merger organization front end may be a computer program, such as a web browser based client application, adapted to communicate via a secure connection with the SISA management offices component of the tool. The SISA management office has a user interface to its component to the secure communication tracking and progress management tool that provides access and review capabilities for various members of the SISA management office so that communications into and out of the can be controlled and tracked for purposes of ensuring compliance with anti-collaborative regulations.

The SISA management office platform in such preferred embodiments also includes a request tracking database in communication with its secure communication tracking and progress management tool component. This database is used to track and catalog all substantive communications into and out of the SISA center via the two platforms, including specification requests and clarification requests of the type generally described above.

The SISA center component of the secure communication tracking and progress management tool running on the SISA center platform has several electronic databases attached thereto. These databases preferably include an electronic database of confidential and sensitive electronic information and data obtained from the organizations, as well as a SISA center request tracking database that is used by the secure communication tracking and progress management tool as a place to catalog all communications within, into and out of the SISA center regarding specification and clarification requests.

In such embodiments of the invention, the SISA center component of the secure communication tracking and progress management tool is in secure electronic communication with both front ends only via the SISA management office platform through suitable security mechanisms such as firewalls, password encrypted secure tunneling architecture channels over the Internet, and the like. The dual components of the secure communication tracking and progress management tool resident on different remotely located by electronically networked electronic computing platforms serves as the primary mechanism for monitoring and enabling communications from SISA center personnel out of the SISA center during its operation under quarantine and the only mechanism for processing clarification requests.

At all times during the process, the request tracking database within the SISA center monitors all activity with respect to a request, while the corresponding tracking databases maintained in the SISA management office's platform and by the pre-merger organization front end(s) only track and catalog clarification request activity that reaches its respective level of dissemination. The redundant levels of legal review permitted by the secure communications tracking and progress management tool, as well as the multiple levels of status tracking using separate and independent request tracking databases afforded by the tool, are significant features of preferred embodiments of the invention. They provide high amounts of assurance that no information will leave the SISA center and be communicated to the merging organizations prior to deal approval/closing if that information could be interpreted or construed as being improper under the governing pre-merger anti-collaboration regulations.

In this regard, a first aspect of the present invention relates to a computing network architecture configured to track and catalog communications within a SISA adapted to facilitate post-merger integration planning tasks for a merger involving one or more merging entities during a regulatory review period. The computing network architecture includes a secure communication tracking and progress management tool adapted to permit users create, track and monitor requests for information. The tool includes a first component and a second component that are adapted to communicate securely with one another. The computing network architecture further includes a secure information facility network located within a SISA center facility. This secure information facility network has first computing means supporting the first component of the tool and a first request tracking database. The computing network architecture also includes a SISA management office network located external to the SISA center facility and in electronic communication with the secure information facility network. This SISA management office network has second computing means supporting the second component of the tool and a second request tracking database. The tool is operable to permit users located within the SISA center to ask clarification questions to persons associated with the merging entities via clarification requests prepared and submitted using forms of the tool. The clarification requests once submitted are automatically cataloged and routed by the tool through at least two levels of legal review. The first level of legal review occurs at the first component and is cataloged in the first request tracking database, and the second level of legal review occurs at the second component and is cataloged in both the first and second request tracking databases.

Additionally, a second aspect of the present invention relates to computing network architecture configured to track and catalog communications within a secure information sharing architecture adapted to facilitate post-merger integration planning tasks for a merger involving one or more merging entities during a regulatory review period. The computing network architecture includes a secure communication tracking and progress management tool adapted to permit users create, track and monitor requests for information. The tool includes a first component and a second component that are adapted to communicate securely with one another. The computing network architecture further includes a secure information facility network located within a SISA center facility. This secure information facility network includes first computing means supporting the first component of the tool and a first request tracking database, where the first component provides a request interface and a first legal review interface to users located within the SISA center facility. The request interface is adapted to allow users within the SISA center to ask clarification questions to persons associated with the merging entities by creating clarification requests prepared and submitted with forms of the tool. The computing network architecture additionally includes a SISA management office network located external to the SISA center facility and in electronic communication with the secure information facility network. This SISA management office network has second computing means supporting the second component of the tool and a second request tracking database. The second component provides a second legal review interface to users located within the SISA center facility. The clarification requests once submitted are automatically cataloged and routed by the tool through at least two levels of legal review. The first level of legal review is triggered by an automated routing of a submitted clarification request to the first legal interface where it must be approved by legal professional users quarantined within the SISA center facility, and the second level of legal review is triggered by an automated routing of the submitted clarification request after it is approved by the legal professional users to the second legal interface where it must be approved by second legal professional users located outside of the SISA center facility. Any activities impacting the clarification request at each level of legal review are cataloged in particular ones of the request tracking databases depending upon from which of the interfaces the activities originate.

Further, a third aspect of the invention includes a secure communication process for supporting the performance of post-merger integration planning tasks within a SISA for a merger involving one or more merging entities during a regulatory review period. The process includes the step of establishing a secure information facility network located within a SISA center facility. This secure information facility network has first computing means and a first request tracking database. The process also includes the step of establishing a SISA management office network located external to the SISA center facility and in electronic communication with the secure information facility network, where the SISA management office network has second computing means and a second request tracking database. Further, the process includes the step of loading a first component of a secure communication tracking and progress management tool on the first computing means and a second component of the tool on the second computing means. Each of the components are adapted to communicate securely with one another to permit users within a respective network to create, track and monitor requests for information. Finally, the process includes the step of operating the tool, wherein the tool is operated by users located within the SISA center to ask clarification questions to persons associated with the merging entities via clarification requests prepared and submitted using forms of the tool. The clarification requests once submitted are automatically cataloged and routed by the tool through at least two levels of legal review. The first level of legal review occurs at the first component and is cataloged in the first request tracking database and the second level of legal review occurs at the second component and is cataloged in both the first and second request tracking databases.

The various features of different embodiments and aspects of the invention having thus been described, preferred embodiments thereof will hereafter be described in detail with respect to several drawings.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 is a schematic diagram depicting an example of a typical timeline of the post-deal phases of a merger or acquisition transaction lifecycle;

FIG. 2 is a schematic diagram depicting one embodiment of a secure information sharing architecture according to the present invention;

FIG. 3a through FIG. 3d collectively depict in flow diagram form a secure information sharing process that establishes and then utilizes a secure information handling architecture during the pre-closing phases of a merger or acquisition integration to accelerate the launching of integrated business activities according to one preferred embodiment of the present invention;

FIG. 4 is a logic schematic diagram depicting the flow of information and communications between various entities according to an secure information sharing process according to one embodiment of the present invention;

FIG. 5 is a schematic diagram of a network for technically implementing a secure information sharing architecture according to one preferred embodiment of the present invention;

FIG. 6 is a flow diagram depicting an example of a tracking and cataloging process utilized by a secure information handling architecture to screen information exiting a quarantined center established using the secure information sharing architecture according to one preferred embodiment of the present invention;

FIG. 7 is a first view of a suitable user interface that illustrates the visible operation of a secure communication tracking and progress management tool according to preferred embodiments of the present invention;

FIG. 8 is a second view of a suitable user interface that illustrates the visible operation of a secure communication tracking and progress management tool according to preferred embodiments of the present invention; and

FIG. 9 is a third view of a suitable user interface that illustrates the visible operation of a secure communication tracking and progress management tool to create clarification requests according to preferred embodiments of the present invention.

### DETAILED DESCRIPTION OF THE PREFERRED EMBODIMENTS

The secure information architecture and related process and tools according to the present invention are able to facilitate and serve all the functions of traditional data clean rooms, but furthermore enables the merging companies to benefit from the performance of high quality, informed baselining analysis during the regulatory review period, anticipation of analysis priorities based on value drivers and relative complexity, the ability to support unanticipated analysis requests from the merging companies, and otherwise enhances readiness for “Day One” (the first day following closing of the merger transaction).

The personnel that establish, support, and primarily utilize the secure information sharing architecture (“SISA”) of the present invention are, of course, an important component to the value of the integration assistance provided by embodiments of the present invention. The personnel are typically financial consultants and other subject matter specialists (collectively, “specialists”), and, as such, these specialists should have the ability to organize and run complex processes in a short period of time and seamlessly using basic technologies and facilities, and deep knowledge of the merging companies obtained through conducting operational projects across all the functions with a role in synergistic value creation. Further, the personnel operating the SISA center (as hereinafter described) should include subject matter specialists in all functional areas, including cross-industry benchmarks and current leading practices. Finally, the SISA personnel should also have persons in leadership positions that have significant experience to provide sound business judgment regarding value priorities, regulatory and legal pressures, cultural sensitivity and executive presence.

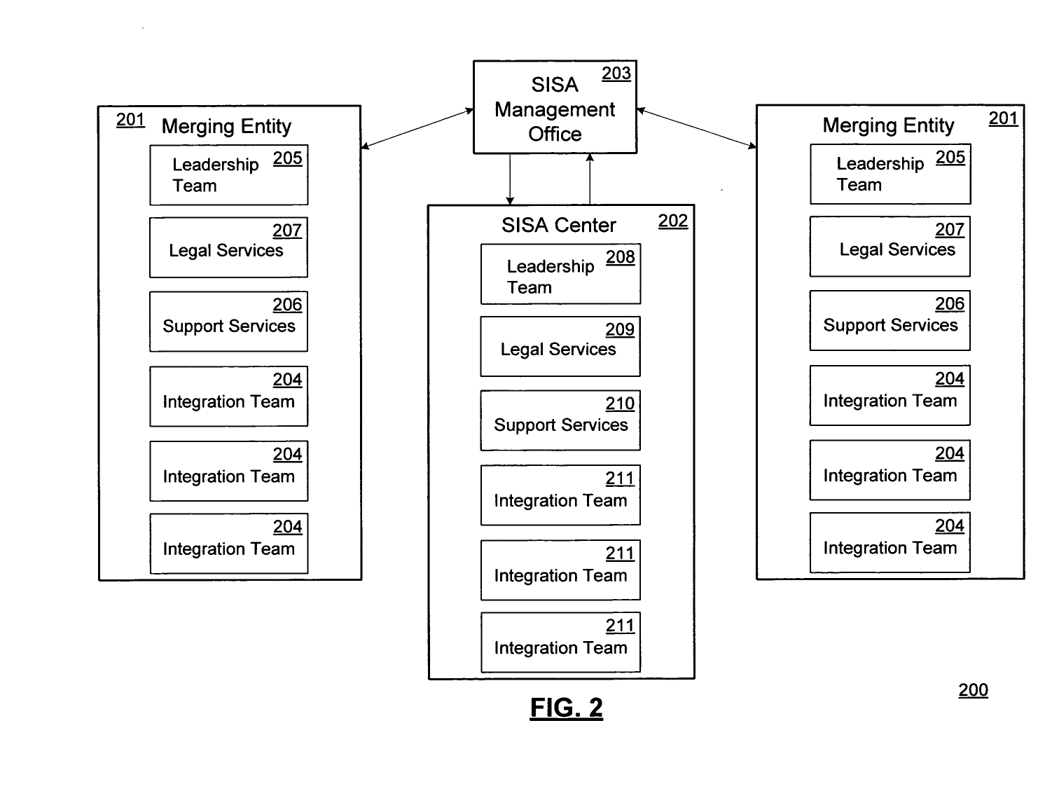

A SISA 200 according to one preferred embodiment of the present invention is depicted in FIG. 2. As shown in FIG. 2, two merging entities 201 are logically connected to a SISA center 202 via a SISA management office 203 during the period of post-merger integration activity preceding closing of the deal (i.e., before legal limitations on information sharing are formally lifted). The SISA management office 203 is responsible for the management of the day-to-day activities of the SISA architecture 200, and comprises a management team that includes include candidates selected from the management and/or employees of one of the original merging entities 201 (usually the business organization that is the acquirer), or candidates can be provided by a specialist or specialist organization (such as a consulting firm or service provider knowledgeable in areas of particular relevance to the merger transaction in question, including those having industry expertise). The SISA management office 203 also preferably includes its own staff of attorneys to provide on-demand legal advice concerning practices for segregating information flows between the merging companies and controlling the flow of information into and out of the secure information repository of the SISA center as described below.

The secure information sharing architecture 200 as depicted in the embodiment of FIG. 2 employs a dual or mirrored organizational structure that permits two levels of post-merger planning to take place on two parallel paths. The first level of planning approximates the pre-closing planning that conventionally takes place for post merger integrations wherein the parties are prevented from conducting collaborative planning until regulatory approval is obtained and closing begins. In this regard, a team of employees from a given merging entity, or consultants hired by that entity, are tasked with independently performing research using only publicly available data regarding the other merging entities to develop business cases, projections, and proposed strategic integration plans. Thus, this first level of planning involves the use of one or more traditional integration planning teams 204, directed and supported by the corporate leadership 205, legal teams 207 and other support services staff 206 of that merging entity, to perform preparatory analyses in planning for post-merger upcoming integration activities.

However, the secure information sharing architecture 200 of embodiments of the present invention further enables collaborative planning to take place in parallel while still complying with all relevant regulatory requirements and restrictions. This collaborative planning is performed by a team of trained and skilled third party specialists that have access to a secure information repository containing sensitive financial and operations data from all of the companies involved in the merger transaction. The secure information repository is maintained and contained within the SISA center 202, and made available to the team of specialists that are selected as SISA center personnel. The SISA center personnel are tasked with similar goals and projects as the specialists on the outside, but operate independently from those specialists up until the date that regulatory approval is obtained and closing occurs (thus lifting all restrictions on collaboration). These specialists are secured within the SISA center 202 formed by the architecture 200 and are in this manner completely segregated from the other “traditional” integration teams 204 of the merging entities 201. In this manner, the personnel in the SISA center 203 can operate independently from the traditional integration teams 204 outside of the SISA center 203 and exploit information that otherwise would be restricted from post-merger planning use until after regulatory approval and closing. Upon closing of the merger, each integration team 211 of the SISA center 202 is preferably allowed to meet with corresponding ones of the integration teams 204 of each of the merging entities 201 to communicate the data compiled by, conclusions drawn by, and proposed integration solutions crafted within the SISA center.

The overall leadership of the SISA, including both the leadership 208 of the SISA center 203 and managers of the SISA management office 202, preferably includes executive-level resources from at least one of the merging companies, and highly qualified lead specialist that is familiar with merger integration planning and operation of the SISA 200. This leadership also most preferably forms a leadership committee that sets and oversees the execution of the overall work plan, acts as key liaison with key stakeholders and reviews and gives approval for key decisions.

The SISA management office is lead by an integration manager that is a specialist that operates on an executive level with regard to running the day to day operations of the SISA, by setting the scope and objectives of the SISA management office, ensuring that SISA processes meet the expectations of the leadership team, and monitoring the integrity of the SISA.

The SISA management office 203 is a dedicated team of program and project managers whose sole focus is facilitating merger integration activities. As will be readily appreciated by one skilled in the art, the SISA management office 203 serves as a communication gateway between the SISA center 202 and the outside world, including integration teams 204 working for or within either of the merging entities 201. As described in further detail below, the SISA management office 203 takes the lead in most logistical and coordinating functions, including mobilizing and coordinating post merger integration activity, tracking progress and results on both the planning side and the execution side of closing, identifying issues and setting agendas.

The SISA management office 203 preferably includes a leadership steering committee that is tasked with establishing merger objectives, designing overall process goals and restrictions, making decisions and/or approvals and resolving conflicts, assigning team leaders to particular functional tasks, and generally creating various demands for research and outputs (such as in the form of formal “specification requests”) by the specialists within the SISA center 202.

Core team members comprising the SISA center personnel include specialists (financial, managerial, etc.) at various levels of expertise and seniority with project management experience and client subject matter experts that are used to form integration teams 211 within the SISA center. SISA personnel also includes necessary support staff 210 and legal resources 209 for helping to develop, facilitate, and perform the functions of the SISA center 203. The integration teams 211, for example, can utilize financial management specialists to examine financial controls and monitor and analyze findings concerning merger integration synergies in order to craft recommendations for management of the merging entities or detailed integration plans (for delivery upon closing).

Program management technology resources are preferably included in the support services staff 210, and can include a manager level specialist with IT expertise who is tasked with managing personnel for and overseeing the tasks of developing, installing and supporting the technical infrastructure to support the SISA 200, including scheduling and reporting tools and related hardware, productivity and communication software, and business applications.

The various integration teams 211 within the SISA center 202, like integration teams 204, are comprised of various specialists tasked with handling specification requests from the SISA management office 203 and their day to day responsibilities include identifying issues, collecting data, and performing analyses to make recommendations to the steering committee. Upon closing, the various external integration teams receive detailed reports from the SISA center and work on reviewing and implementing the recommendations of those reports in the early post-merger integration phase.

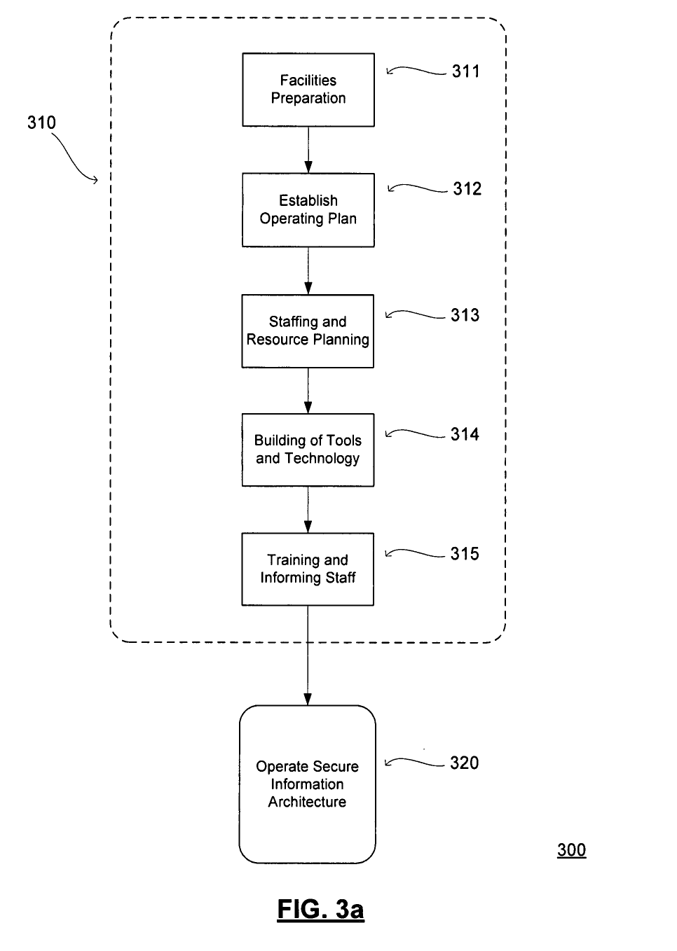

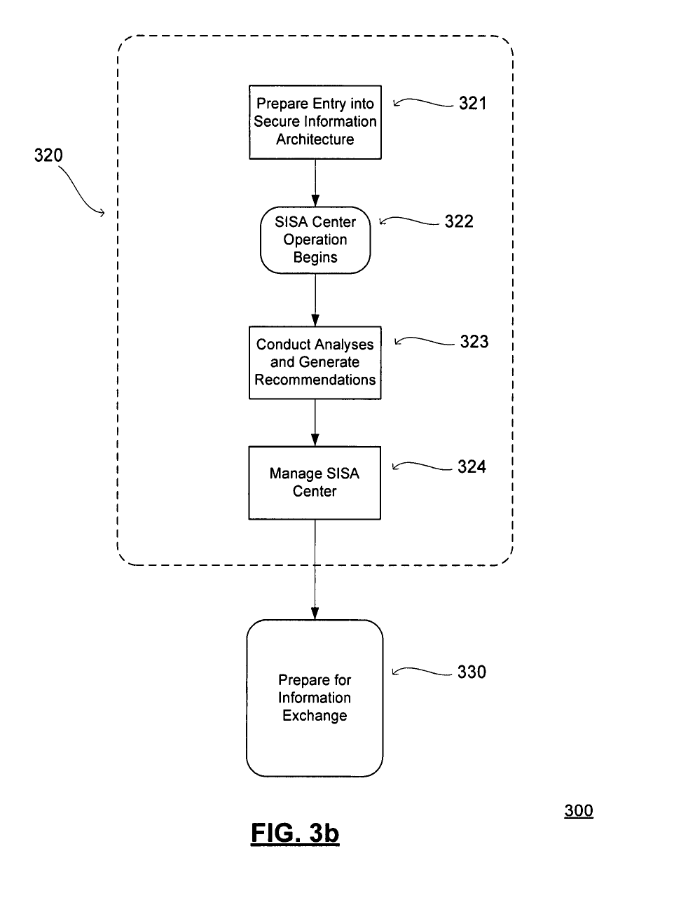

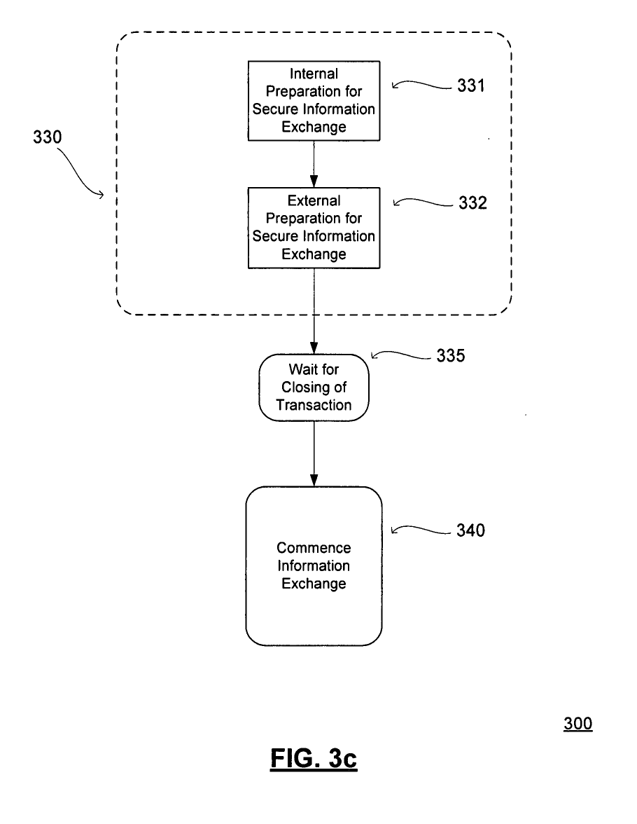

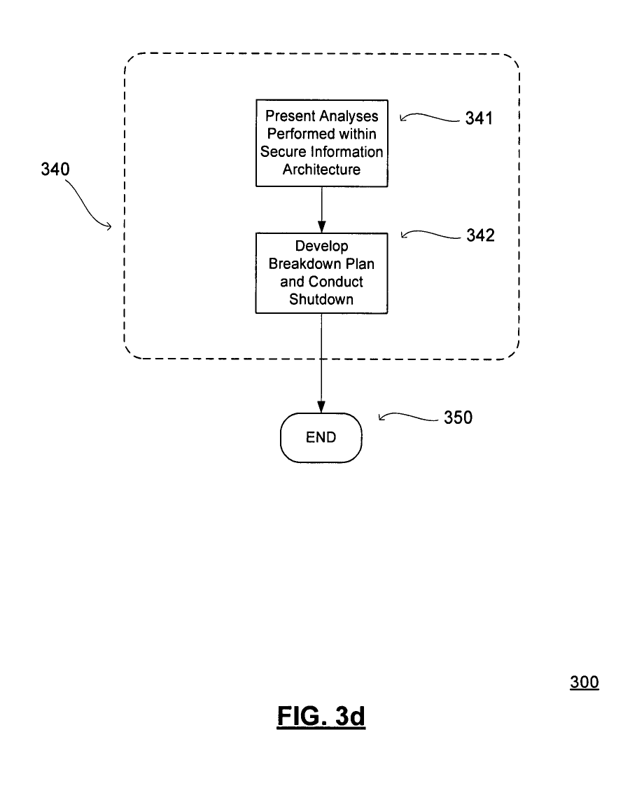

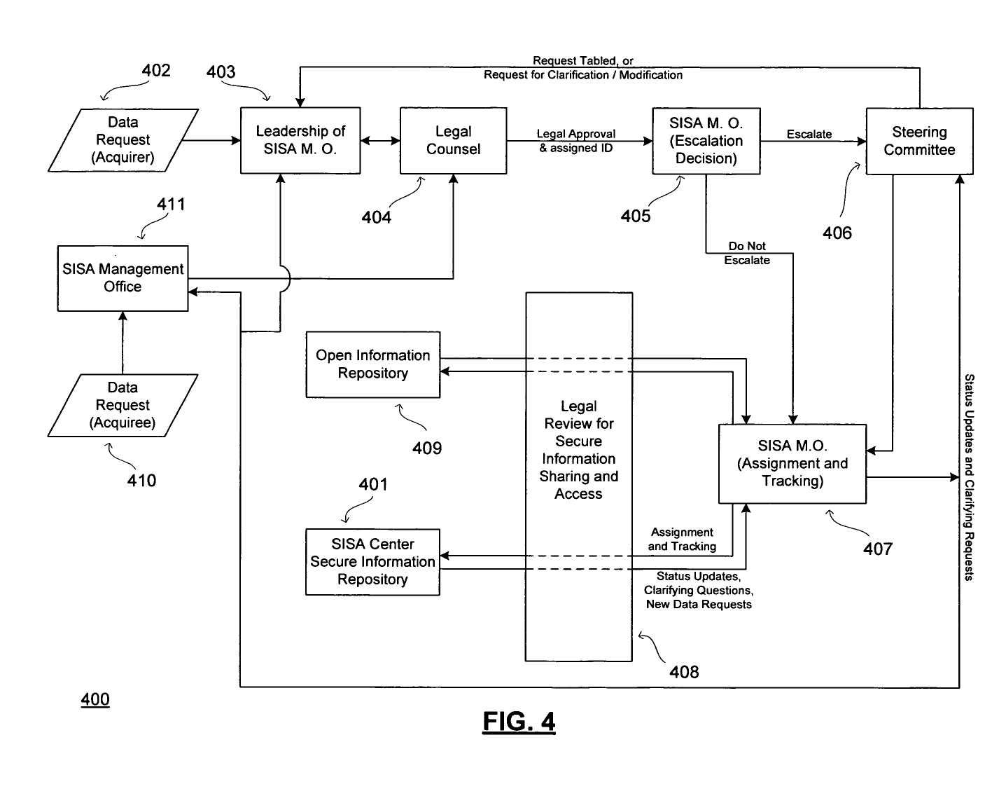

While the architecture 200 of FIG. 2 is depicted as having two merging entities 201, the above description of the operation of this embodiment of the present invention can be readily adapted by one skilled in the art to a situation where three or more business organizations are involved in the merger or acquisition deal and are desired to receive benefits of the SISA center. Further, while each merging entity 201 is shown as having integration teams 204 that operate independently from the teams of the other entity or integration teams 211 within the SISA center 202, it should likewise be understood that it is not required for all merging entities to employ the same number of integration teams, or even for more than one merging entity 201 to employ any integration teams 204 at all. However, as will be made clear below, it would be advantageous and thus preferred that the SISA 200 be established such that each integration team 211 in the SISA center 202 corresponds to at least one integration team 204 run by or on behalf of at least one of the merging entities 201. The various configurations of the SISA 200 will be more readily understood after consideration of FIG. 3a through FIG. 4, as described hereafter.

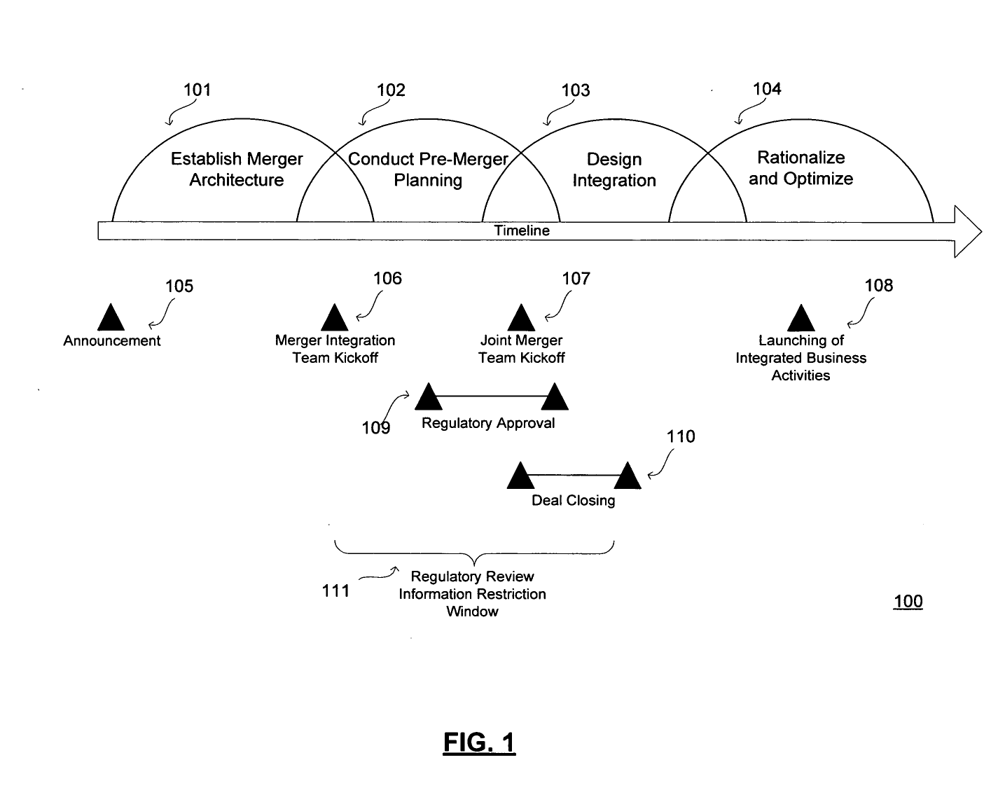

FIG. 3a through FIG. 3d collectively depict in flow diagram form a secure information sharing process 400 that establishes and then utilizes a SISA during the pre-closing phases of a merger or acquisition integration to accelerate the launching of integrated business activities according to one preferred embodiment of the present invention. Process 300 begins during a period before the merger or acquisition deal is closed and proceeds within the regulatory review information restriction window (as depicted and described above with respect to FIG. 1). Preferably, information sharing process 300 is initiated at an early time following announcement of the deal such that logistical preparations necessary for secure information sharing to commence can be made in accordance with the architecture of the invention.

As depicted in FIG. 3a through FIG. 3d, the process 300 can be conceptualized as comprising four consecutive phases. The mobilization phase 310, the first phase that begins the process 300, is depicted in FIG. 3a in detail as comprising five constituent steps. The mobilization phase 310 and process 300 both begin with the preparation of facilities at step 311. This step entails the design and build-out the physical site and facilities that will house a secure information repository and associated personnel, which facilities are termed herein a “SISA center” and personnel termed herein as comprising the “SISA personnel” or “SISA team.” During this step, it is important to ensure that the center is compliant with overall security and legal requirements. By the end of step 311, a physical site selection should be made, along with a business case presented supporting the selection of the specific location. Typically, it is best that the selected site be neutral with regard to merging companies, however convenience usually dictates that the location is in a town or city near the acquirer's headquarter (to facilitate post-closing open information sharing) but in a separate location.

Additionally, leases or contracts should be executed, and the floor plan, layout and technical infrastructure (number of phone lines, LAN connections, and other technical considerations) of the facility should be established at least roughly. The facility and floor plan for the SISA center would, for example, maximize functional team's efficiencies by clustering appropriate teams together. Finally and importantly, the security plan for the chosen facility should be established. This plan will create secure data and security storage areas with attendant security protocols.

Next, step 312 entails the establishing of the operating plan for the SISA center and its personnel. This step therefore develops the overall processes, policies and guidelines for operating the SISA center, which drives the build-out of the actual SISA center facilities and the supporting security tools and technology platform. The results of step 312 are reflected mainly in official guidelines and policies that will govern the use of information and data within the center and how information flow is controlled into and out of the SISA center. These guidelines describe protocols for ingraining the significant legal oversight and approvals needed to monitor the information flows. These protocols should address how data will move in and out of the SISA center's secure information repository, and address how exception cases will be handled including clarifying questions.

Typically, step 312 will also include the establishment, in conjunction with the merging company (or companies) that have requested utilization of the SISA and that company's legal counsel the security levels required for the SISA center. The protocols and security clearances work together to identify the different scenarios by which information might need to go into or out of the SISA center and stipulate documentation and tracking process flows that are designed to limit chances for a legal breach. For example, it could be established that SISA team members cannot bring briefcases or laptops into the SISA center facilities, and that all computers except a select few in the SISA center facilities will configured to prevent the copying of files to portable writable storage (floppy disk, CD-R/CD-RW and DVD-R/DVD-RW, thumb drive, or the like).

Finally, it is preferable that the operating plan established in step 312 incorporate the presence of legal counsel inside the SISA center facilities as a full time part of the SISA team, enabling this SISA “in-house” counsel to communicate with legal counsel on the outside to facilitate communications into and out of the SISA center.

Vague definitions of success should be avoided at this step with the goal of establishing a post merger process and plan that have clear focus on measurable areas of value creation including metrics. Post-merger integration goals should be set and made easily understandable and financially driven. Any synergy-related targets and goals should be reflected inherently within these targets and goals in a manner that it can be measured with respect to the ongoing operative budgets of the post-merger business. Non-financial strategic definitions are considered non-preferred unless they a financial basis and can be clearly translated into financial outcomes (e.g., incremental cash flow returned in the form of increased shareholder value).

Step 313 entails the planning for personnel and staffing of the SISA center and the non-personnel resources that the center will require. This step therefore requires lead specialists, who will ultimately serve leadership roles inside of the SISA center during operation, to identify the appropriate personnel and other resources for the SISA center and establish appropriate plans for rolling resources into the center.

A typical staffing plan will call for a leadership team to be established, with an identification of key persons that should serve on the leadership team, and will also provide a high-level organization chart. Key staffing terms and accompanying employment contracts (e.g., confidentiality agreements) should also be prepared during this step.

The staffing plan preferably also identifies personnel that is necessary to operate the SISA center on the inside as well as to support the SISA center from the outside via the SISA management office. For example, specialists should be enlisted according to their individual experience and skill set to ensure that the knowledge base in the SISA center represents all companies involved in the merger. The specialists that will serve on staff in the SISA center should be identified as early as possible such that they can begin to gather publicly available knowledge as much as possible while on the “outside” to gain greatest clarity regarding requests before communications become scrutinized and/or minimized in accord with the SISA procedures.

Also, it is preferable that not only does the SISA center personnel include inside attorneys, but that those attorneys include some that are experienced anti-trust legal counsel. Most preferably, such anti-trust legal counsel should also be present on the support teams outside of the SISA center to facilitate clarifications and legal concerns.

Finally, the resource plan established in step 313 should identify appropriate resources by area and provide an appropriate roll-on schedule those resources. For example, moving of resources into the SISA center should be staggered as appropriate, with, for example, furniture being delivered before office supplies and communications equipment to eliminate unnecessary efforts in initial set up.

Step 314 as depicted in FIG. 3a entails the building of tools and technology necessary to enable the SISA and support the SISA center. During step 314, experienced IT personnel are employed to develop and install a technology infrastructure to holistically support the SISA center and integrate the center with activities of the outside support teams that are working directly with one or more of the merging companies.

Deliverables from step 314 include detailed statements of technology requirements for the clean room and a technical platform blueprint to support the SISA communications and information flows. At this step, any necessary software tools should be identified and either obtained, or designed and implemented. Additionally, templates should be designed for communications into and out of the SISA center.

With regard to the SISA technical platform, it is important that it include clearly defined security requirements and constraints for the various communication and information applications and support the definition of roles and responsibilities of users in relationship to secure information handling processes as described in further detail herein.

Finally, it is also important that the SISA technical platform be up and operational in advance of the SISA center receiving the initial information deposit from the merging companies and the information quarantine starting. Thus, all installation and testing activities for the SISA technical platform should be scheduled to occur significantly in advance of the targeted quarantine date.

The mobilization phase 310 finally concludes at step 315 with the formal training, informing, and orienting of the personnel that will staff the various aspects of the SISA architecture, including those that will operate within the quarantine environment of the SISA center and those that will support the SISA from the outside via the SISA management office. Within step 315, particular care is taken to ensure that key personnel are trained appropriately to ensure compliance with anti-trust and regulatory requirements.

One suitable way in which to perform training and informing step 315 could be to implement a training plan that details the various requirements for different groups of personnel trainees and, in particular, identifies how their role integrates into the overall SISA, from information flow tracking to logistics.

All training materials used in this step should preferably first obtain legal approval. Anti-trust lawyers should be heavily involved in content development and professional learning specialists utilized in the actual driving of the delivery for optimum effect.

Following the training and informing of staff at step 315, the mobilization phase 310 of process 300 is complete and the operation of the SISA phase 320 begins. The various steps comprising phase 320 are depicted in detail in FIG. 3b.

Referring now to FIG. 3b, it can be seen that the operation phase 310 begins with the preparation for execution of the SISA and entry into the SISA center at step 321. At this time, the SISA personnel begin to develop the work plans and requests for the specifications that will be completed in the SISA center.

These specifications are the primary mechanism by which the SISA creates and delivers value to the post merger integration process. freed of the constraints imposed by the SEC anti-collaboration window by the SISA, the specialists that are SISA center personnel are permitted to review information that normally would be restricted for sharing during the anti-collaboration window. The specifications reflect specific requests made by the management of the merging companies for research into how to best realize the objectives of the merger transaction.

Prior to quarantining of the SISA center, and therefore prior to the review of any restricted information and data, the specification requests are analyzed and specification work plans are created.

Such specification requests can include data requests, where one of the merging entities has a research request that they wish to be fulfilled to facilitate or answer questions concerning business plans or decisions that they intend to implement in the rationalization and optimization phase following closing of the transaction.

Such data requests, for example, will provide specific details, including time periods in questions, sample charts, etc. Legal review is conducted of all data requests and synthesized such that only “clean” data is utilized within the SISA center. In practice, the work plans should identify the particular decisions and/or issues that need to be resolved first.

Preferably, a flexible administrative staff is maintained to assist in peak times and assign point people for specific divisions to reduce number of interfaces.

At the point in time 322 represented in phase 320, the SISA center is ready for operation, and the quarantining of information and data within the SISA secure information repository and the SISA personnel in accord with the establishes SISA architecture begins.

Phase 320 thereafter continues at step 323 with the conducting of analyses and generation of recommendations to satisfy the specification requests according to the work plans. In particular, at step 323, the SISA personnel will collect and review data from both companies and complete the specification requests in independent fashion from influence of the merging companies until such time as the merger transaction closing is completed. Step 323 therefore represents the time period wherein the SISA established in the mobilization phase 310 begins to be utilized and value creation begins.

In the time period of step 323, the specialists who were selected to be SISA center personnel are freed to review the information and data in the secure information repository for the completion of data and specification requests and use that information to make strategic judgments and forecasts and prepare deliverables for review by managers of the resulting post-merger entity once appropriate regulatory approvals have been obtained, closing has proceeded, and all legal prohibitions on sharing and utilization of the information between the merging companies has been lifted.

Deliverables prepared during this time period can include project deliverable packs for each specification request, which can provide functional summaries, detailed financial projections and costs analyses, and executive insights and memoranda.

At this point, communication with support personnel and management of the merging companies outside by SISA center personnel is greatly restricted and allowed only via the SISA management office and only in so far as those communications meet stringent criteria. These criteria are monitored and enforced in large part by in-house and outside legal counsel and electronic information management tools to implement the desired and necessary security processes. An example of such a security process that can be utilized during quarantining of the SISA center is the secure information handling process described below with respect to FIG. 4.

Communication by the SISA center personnel with outside entities at this time can be made when necessary so long as information integrity within the secure information repository is maintained. For example, sample deliverables that are not specific to the industry of the project can be used to inform the outside generically of the format of deliverables that should be expected once the quarantine is lifted and can be used in the interim in making analogies for project discussions. Similarly, from time to time it will be necessary for specialists who are SISA personnel to request guidance regarding the specification requests. In this regard, clarification requests containing clarifying questions, upon getting approval following legal review, can be sent out of the SISA center to the originator of the specification request (e.g., a management team for one of the merging entities) to resolve ambiguities.

Phase 320 thereafter continues with step 324 wherein the managing of the SISA center takes place. Understandably, steps 323 and 324 are complementary in nature and their underlying functions and tasks are performed according to the SISA at the same time. Step 324 represents the various administrative steps that occur while the SISA center is operating in its quarantined state and securely handling data and information requests according to the SISA. The tasks represented here include managing the progress of SISA center in meeting the specification requests submitted into the SISA, and monitors personnel activities and communications to ensure that they stay on track to complete specification requests and related projects on time before the SISA center quarantine is lifted once the merger transaction has been approved and closes.

During this step, the SISA center utilizes various tools to monitor productivity, schedules and information flows, which tools provide, for example, issue logs, regular status reports, mechanisms for creating, clearing legally, submitting, and tracking clarifying questions, and new specification/data requests and request change logs for communications coming into the SISA center from outside support staff and management of the merging companies. The outside support staff and team will manage all the process and reporting that are external to the SISA center, with all contacts flowing into and out of the SISA center passing through at least one level of legal review (either by inside or outside counsel, and preferably both as described further below).

As will be readily appreciated by one skilled in the art, the operating phase 320 of process 300 will of course take place for as long as the SISA center is operating in its quarantined state. SISA center personnel will be given updated timelines and reports concerning the regulatory review process and expected closing timelines as they occur so that planned progress for the completion of various specification requests can be updated as necessary. Upon completion of the operations phase 320, the information exchange preparations phase 330 begins. The constituent steps of phase 330 are depicted in detail in FIG. 3c.

Referring now to FIG. 3c, the first step 331 of the information exchange preparations phase 330 is depicted as comprising the internal preparation within the SISA center by SISA personnel for the actual exchanging of the information and analyses performed in the SISA center during operations phase 320. In particular, this step entails preparation by the SISA personnel for releasing it's analysis and recommendations, and, in this period of process 300, the SISA center will set expectations of what the post merger integration teams working with the SISA management office will receive.

For example, the SISA center can prepare memoranda clarifying what deliverables are to be expected, with detailed list of reports and projects. This facilitates communication between the SISA center and the outside to ensure that both outside companies know what is coming out of the clean room. Additionally, various administrative tasks will be undertaken within the SISA center at this time, including preparation of the contents of the secure information repository for return to the merging entities and/or storage, such as by preparing shipping labels, packing lists, and the like. Additionally, archiving of electronic data could be begun.

Next, at step 332 (or concurrently with step 331), the SISA management office and various post merger integration teams outside the SISA center will coordinate how the analyses and recommendations prepared by the SISA personnel will be delivered upon closing of the merger transaction. The post merger integration team will, for example, coordinate various read out sessions that will take place, and will allocate delivery of various SISA personnel deliverables (specifications) to the appropriate integration teams and team members to minimize delays caused in handoffs.

Phase 330 is completed when the tasks comprising steps 331 and 332 are completed. At this time, process 300 waits at time period 335 to enter the final phase, the information exchange commencement phase 340, which phase will not begin until the date of closing.

Upon the day of closing, the information exchange commencement phase 340 of process 300 initiates as depicted in FIG. 3d with step 341. In this first step, the SISA center personnel's specialists present the results of the various analyses performed according to the specifications while within the SISA center. At this time, executive and functional team readout sessions occur in coordinated fashion. In particular, this information exchange can be arranged in conventional manners, with executive-level overview meetings, functional integration team overview sessions, functional team detailed discussion breakout sessions, and the like.

Preferably, high priority project readout sessions are scheduled to take place near the beginning information exchange process, with sufficient time being scheduled for high value participants to read reports and review data in sufficient depth prior to detailed meetings.

Finally, at step 342 a breakdown plan is developed and shutdown of the SISA and SISA center is conducted. A complete breakdown plan is used to facilitate the transfer of SISA center data and files to appropriate locations and persons, and to dispose of and/or redistribute the SISA center's technology resources as appropriate. For example, during this step a list of all vendors, including an inventory of what is on lease from them, terms of payment, etc., could be compiled and followed.

Understandably, specialists that were members of the SISA center personnel are preferably absorbed into functional teams of specialists within the merging entities or resulting entity that are in charge of implementing the actual post merger integration plans and projects developed as a result of the SISA center activities. This absorption facilitates handoffs and further speeds up the post merger integration progress. Process 300 thereafter ends at time 350.

Turning now to FIG. 4, there is schematically depicted various information flows through a secure information handling process 400 according to one preferred embodiment of the present invention. Process 400 reflects how the SISA addresses how data and information requests generally move into and out of the SISA center, and how exception cases (such as where legal cautions are raised or where clarifying questions are asked) will be handled. In particular, in FIG. 4 there is depicted a secure information repository 401, which repository would be the actual secure information and data archives contained in a SISA center according to embodiments of the invention. Access to the data contained in the information repository 401 of the SISA center is tightly controlled according the established SISA procedures, which procedures in part include the secure information handling process 400. As shown in FIG. 4, information flows between the various different entities communicate data and requests with one another concerning the merger transaction. These communications can, for example, concern requests from one of the merging companies, or from the SISA management office, for information stored in the secure information repository 401 or, alternatively, in an open information repository 409 (which contains information capable of being freely shared among all parties to the merger transaction). The depicted communications and information flows also support new specification requests originating from the merging companies (acquirer or acquiree) or the SISA management office while the SISA center is operating in its secure, quarantined state (i.e., prior to closing).

For example, FIG. 4 depicts new data and specification requests coming from the acquirer merging entity at 420, which requests are then communicated directly to the leadership of the SISA management office at 403. The leadership 403 reviews and processes the request with the help of legal counsel 404 (outside of the SISA center), which legal counsel then, if appropriate, grants legal approval to the request, assigns it a request ID, and forwards the approved request to appropriate personnel 405 in the SISA management office that are tasked with making an escalation decision regarding the request.

FIG. 4 also depicts the parallel situation where depicts new data and specification requests originate from the acquiree merging entity at 410. As the acquiree is required to maintain arms-length transactions with organizations of the acquirer merging entity, which include the SISA management office (which typically are contractors of the acquirer), such requests 410 are communicated directly to legal counsel 404 by the SISA management office at 411 without the input or review by the leadership of the SISA management office at 403. The legal counsel 404 then reviews the request. Approved requests are assigned request IDs in similar fashion to data requests 402 and then likewise sent for an escalation decision.

The escalation decision undertaken by personnel 405 determines whether the communicated request is of the standard type that should be transmitted directly to the SISA center, or whether the request in question concerns a strategically important issue that should be directed to the steering committee 406. This decision would not be performed on an ad hoc basis, but rather would be made according to detailed predetermined criteria established prior to quarantining of the SISA center. If the request triggers and number of escalation flags according to the predetermined criteria, the request is escalated directly to the steering committee at 406. If no escalation flags are triggered, then the request is not escalated and is sent directly to the SISA management office personnel or group in charge of assignments and requests tracking in the SISA center, as denoted at 407.

This SISA management office tracking group 407 then routes any communications through the SISA center's internal legal review team 408, which team makes the determination whether to route the requests into the SISA center (which handles the request utilizing information and data contained in the secure information repository 401) or the determination that the request can be handled utilizing only information from the open information repository 409. Understandably, the legal review team 408 also can refuse to honor any assignments or requests for information that it determines will violate the security rules of the SISA.

As indicated in FIG. 4, there is significant feedback that is permitted to take place according to the secure information handling process 400. While the SISA management office tracking group transmits assignments and requests into the SISA center, the SISA center also transmits information back out through legal review 408, including status updates (such that SISA management office group 407 can update progress reports and other tracking information), clarifying questions concerning the scope of the request/specification, and requests for new data to be submitted by the merging entities into the secure information repository 401.

As represented by the information flows depicted in FIG. 4, the status updates and various requests are then routed by the SISA management office assignment and tracking group 407 to various destinations as necessary, including to the steering committee 406, to the SISA management office 411, or to the SISA management office leadership 403.

One of ordinary skill in the art should appreciate that the information flows and communications provided in FIG. 4 are intended to conceptually depict how various persons and groups communicate securely utilizing the SISA according to embodiments of the invention. Thus, it should be understood that the process 400 depicted is only one such process and as presented depicts only major information flow between the primary groups that are typically necessarily involved in requests concerning the sensitive business information secured in the SISA center.

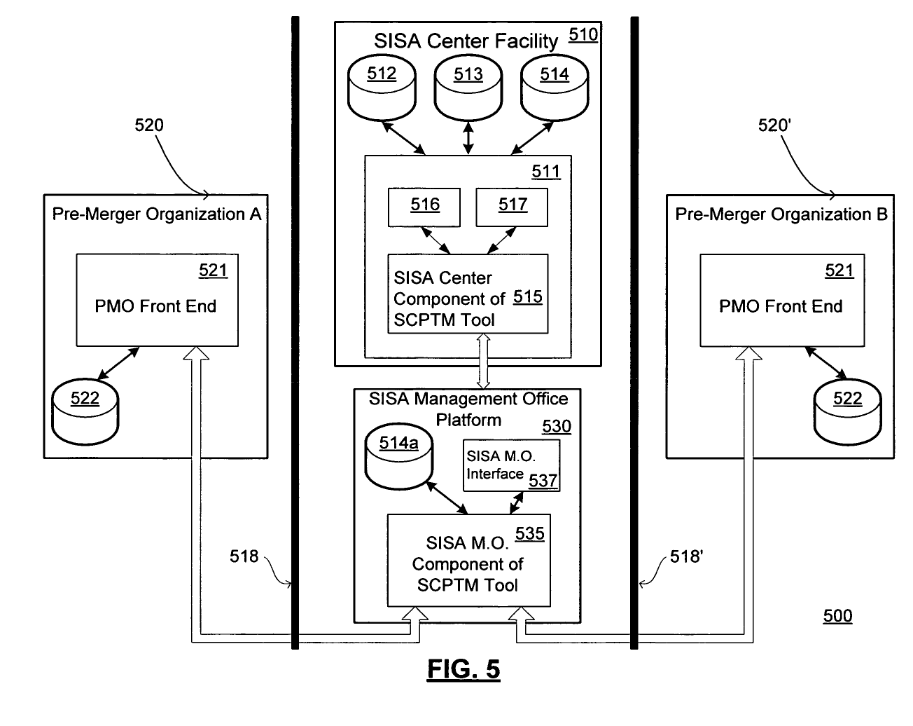

A suitable electronic platform 500 and related tools for integrating communication systems of SISA management office, which offices may represent one or more of the merging entities, and the SISA center is depicted schematically in FIG. 5. FIG. 5 depicts the common case of a two company merger or acquisition, involving an acquirer company 520 (pre-merger organization A) and an acquiree company 520′ (pre-merger organization B). The actual SISA center facility 510 is depicted in FIG. 5 as being remotely located from both pre-merger organizations 520 and 520′. In many circumstances, it is expected that the SISA will be deployed at the request and expense of the organization playing the role of the acquirer company in the merger transaction. Thus, the SISA management office will typically deal directly with only one of the two pre-merger organizations, namely the acquirer company. In the example platform 500 depicted in FIG. 5, however, there are pre-merger organization (“PMO”) front ends 521 for each of the pre-merger organizations 520 and 520′ for purposes of illustration.

Each PMO front end 521 is in communication with a SISA management office computing platform 530, which includes a SISA management office component of a secure communication tracking and progress management tool 535, which component 535 in turn is in communication with an electronic platform 511 of the SISA center facility 510 (“secure communication tracking and progress management tool” being abbreviated in FIG. 5 as “SCTPM tool”). PMO front end 521 may be a computer program running on any suitable computing platform as is known in the art, such as a network of computers configured to perform the functions as hereinafter described, such as a web browser based client application. The SISA management office has a user interface 537 to its component 535 to the secure communication tracking and progress management tool that provides access and review capabilities for various members of the SISA management office so that communications into and out of the SISA center via component 535 can be controlled and tracked for purposes of ensuring compliance with anti-collaborative regulations.

Notably, SISA management office platform 530 also includes a request tracking database 514a in communication with its secure communication tracking and progress management tool component 535. This database is used to track and catalog all substantive communications into and out of the SISA center via the platform 500, including specification requests and clarification requests of the type generally described above.

Within the SISA center facility 510 there is located a SISA center component of the secure communication tracking and progress management tool 515 running on the SISA center platform 511 that has several electronic databases attached thereto. These databases can include an electronic database 512 of confidential and sensitive electronic information and data obtained from the organizations, as well as a SISA center request tracking database 514 that is used by the secure communication tracking and progress management tool as a place to catalog all communications within, into and out of the SISA center regarding specification and clarification requests.

The SISA center component of the secure communication tracking and progress management tool 515 is in secure electronic communication with both front ends 521 only via the SISA management office platform 530 through security means 518 and 518′, which means may include firewalls, password encrypted secure tunneling architecture channels over the Internet, and the like. The dual components 515 and 535 of the secure communication tracking and progress management tool serves as the primary mechanism for monitoring and enabling communications from SISA center personnel out of the SISA center during its operation under quarantine and the only mechanism for processing clarification requests.

As will be described in further detail below, a new data request or specification request from one of the merging organizations, or a clarification request from a member of one of the functional integration teams working within the SISA center, is entered into an electronic form provided by a user interface of one of the PMO front ends 522 (in the case of new specification requests) or via a SISA center integration team interface 517 to component 515 (in the case of a new clarification request). These forms provide both open ended questions and questions having drop down menu selectable answers intended to make the requester enter sufficient data to both fully describe their new (or modified) request for legal review by the SISA management office and SISA center legal teams, but also optimally in a manner that will ultimately enable the specialists within and outside of the SISA center to fully understand and complete the request with a minimum of further communication from the requester.

The component 535 routes requests automatically among the appropriate members of the SISA management office (steering committee, legal, etc.) to ensure that it is handled according to a secure information handling process, such as the exemplary handling process described above with respect to FIG. 4, before the request is cleared for electronic submission to the SISA center personnel via the legal team user interface 516 to SISA center tool component 515 inside the SISA center facility. Legal counsel within the SISA center would then use their interface 516 to the tool to review and approve or reject the communication/request.

In similar fashion, clarification requests are sent out from the SISA center electronic tool platform 511 via component 515 to the SISA management component 535, reviewed by the legal counsel of the SISA management office via interface 537, and then, if approved, routed to the appropriate pre-merger organization 520 or 520′ via their appropriate PMO front end 521. The underlying questions for the requests can then be routed to appropriate persons to obtain the necessary clarifications and segregated among the various organizations 520 and 520′ as necessary.

Each front end 521 has associated with it a local request tracking database 522 for tracking the status of all requests (legal status, escalations status, assignment status, IDs, and the like) and for keeping logs of all communications originating from the front end 521 into the SISA center. In this regard, databases 522 each act as local request tracking databases for all clarification request communications that ultimately reach the respective pre-merger organizations from the SISA center.

Similarly, the SISA center component of the secure communication tracking and progress management tool 515 includes a specification request status database 513 maintained securely accessible only within electronic tool platform 511. This database 513 also primarily serves as a repository for information on the working progress status of all data and specification requests, including project scheduling information for the various specification request work plans (including timelines, status, expected completion dates, important benchmarks, etc.). In this manner, the request management tool may provide high level managers within the SISA center the ability to monitor in real time the status of all projects within the SISA center while being certain that information security is being maintained throughout the quarantine period.

It should also be understood that electronic tool platform 511 would also preferably support other electronic tools needed by the SISA personnel, including productivity tools (such as word processing applications, spreadsheet applications, and the like) and project management tools (such as task assignment and tracking applications, interoffice email and scheduling applications and the like).

As will be readily appreciated by one skilled in the art, the use of an electronic platform such as that depicted in FIG. 5 to support a SISA according to embodiments of the invention has various advantages in addition to merely tracking the information into and out of the SISA center. In particular, since specification requests and clarification requests are submitted and transmitted via electronic forms using such a platform, the platform preferably can be configured with various productivity monitoring and management tools that automatically track timelines and status of various tasks associated with each request as described in further detail below.

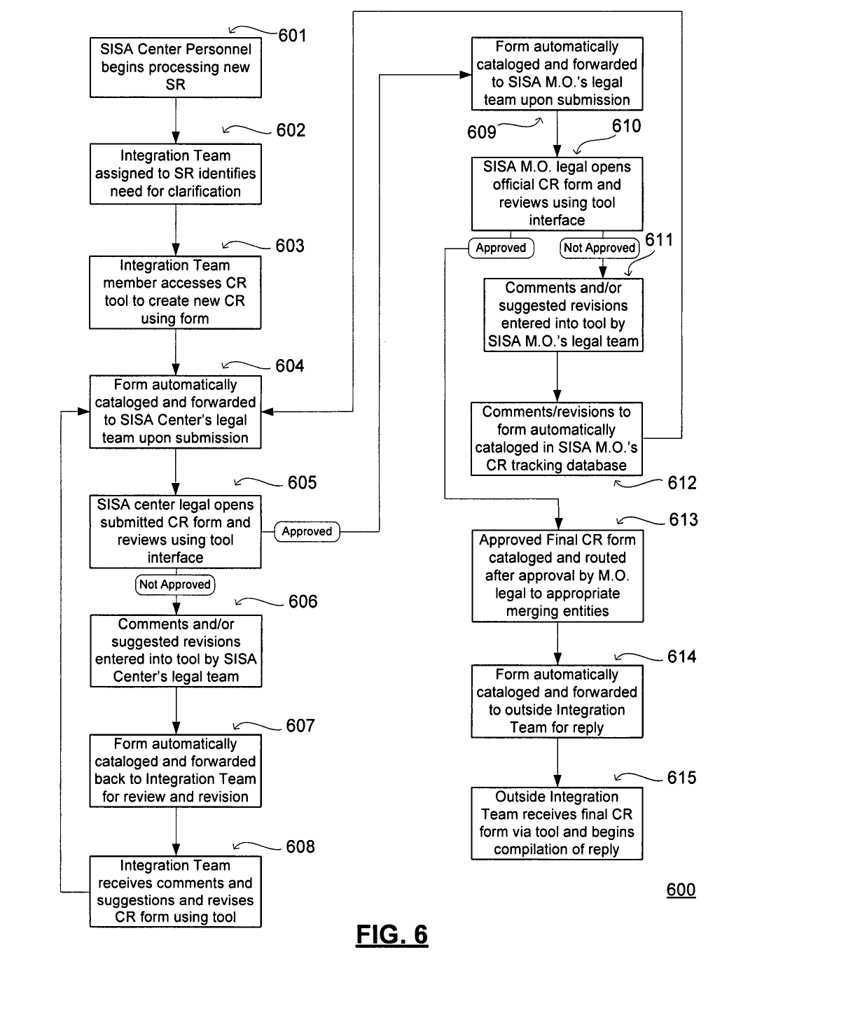

With this understanding of a suitable network in mind, description will now be provided with regard to a process by which such a network will operate to track information leaving a SISA center according to embodiments of the present invention while still preventing improper leaks of sensitive business information from the secure information repositories. As shown in the flow diagram of FIG. 6, a tracking and cataloging process 600 utilized by a secure information handling architecture to screen information exiting a quarantined SISA center according to one preferred embodiment of the present invention is initiated by the SISA center personnel quarantined within the SISA center beginning to review a specific specification request (abbreviated as “SR” in FIG. 6) at step 601. As described above, an integration team within the SISA center would be assigned to the specification request, and would begin working on researching and planning activities associated with that specification request immediately following quarantining of the SISA center. At some point in time later, step 602, the integration team would identify a need for clarification (e.g., additional data, or updated financial/strategic goals of one or more of the merging entities) in order for the team to fully respond to and address the specification request.

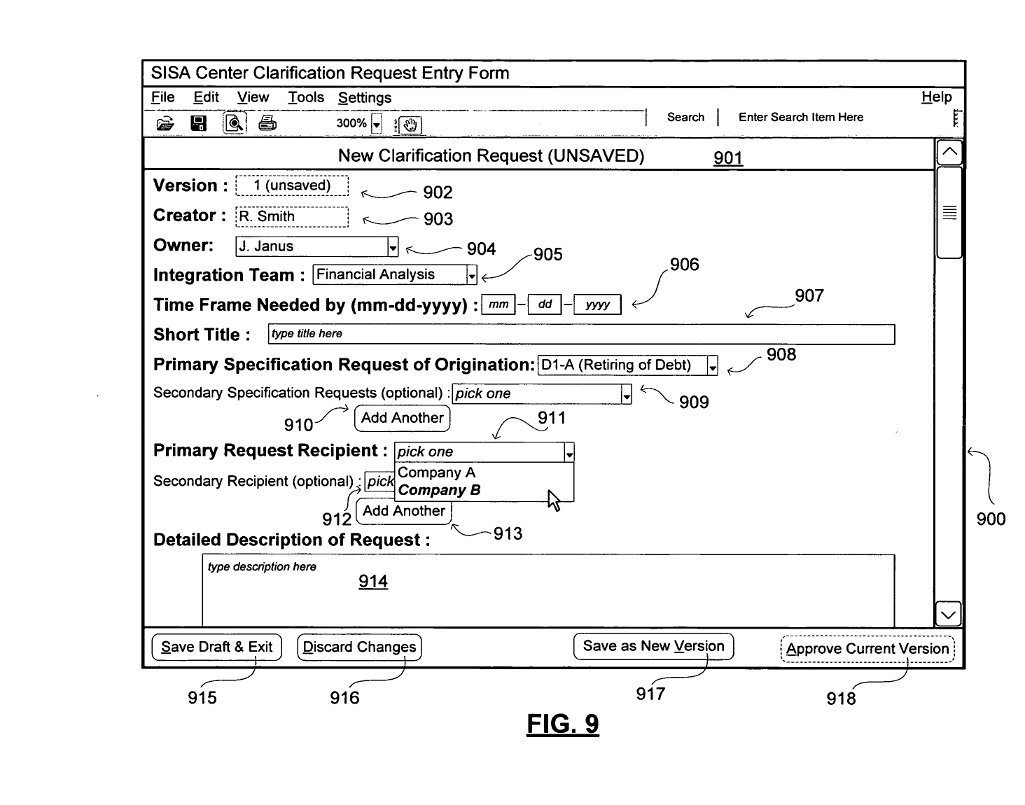

Upon identifying a need for clarification, the only way for an integration team within the SISA center to request information from the merging entities is via a clarification request (abbreviated as “CR” in FIG. 6). In preferred embodiments of the invention as depicted in FIG. 5 and FIG. 6, the secure communication tracking and progress management tool accessed via the tool's interface in the SISA center would provide a form-based interface to members of the integration teams to collect information from the user to prepare a new formal clarification request at step 603. A suitable format of such a form, and the type of information that would be collected by the form, is described in further detail below with respect to FIG. 9.

Upon completion and submission of the form, as noted above, the secure communication tracking and progress management tool automatically catalogs the form in a request tracking database within the internal networking platform of the SISA center (e.g. database 514 of FIG. 5), and then forwards that form to a SISA center legal team member for review to start the approval process. The request tracking database would be updated to catalog the new request by having a time stamped copy of the entire clarification request, metatagged with information such as the identity of the creator/submitter, a unique clarification request ID assigned by the tool, associated or related clarification requests and/or specification requests, and other like information as described below with respect to the example of FIG. 9.

With regard to forwarding of the submitted clarification request form for legal approval, for example, the secure communication tracking and progress management tool could notify the legal team via an automatically generated email message that a new clarification request form has been submitted that needs action. Preferably, such a notification email could provide a clickable link that would automatically direct the recipient of the email to a view provided by the secure communication tracking and progress management tool for reviewing the new form submission and ultimately commenting upon, revising, or approving the clarification request form.

Upon the secure communication tracking and progress management tool forwarding the clarification request form to the SISA center's legal team, a member of that legal team opens the clarification request form using a reviewing interface provided by the tool to initiate at step 605 the necessary legal review before the clarification request is permitted to exit the SISA center. Understandably, most newly submitted clarification request forms will not be approved by the SISA center's legal team initially. It is expected that in most situations the legal team member reviewing the new form will likely have comments or questions regarding the form, require changes to or deletions from the form, or otherwise require follow up by the submitting person or submitting integration team. The legal review interface of the secure communication tracking and progress management tool would therefore enable the legal team member to enter such comments, suggested revisions, questions, and other like feedback, when the form is not approved at step 606, and then have that feedback cataloged in the SISA center's request tracking database and forwarded back to the submitter(s) automatically by the tool at step 607 as depicted. Again, at step 607 a notification could be sent to the submitter(s), such as via an automated email created by the tool, communicating that the clarification request form was reviewed by the SISA center legal team and not approved, and that the clarification request form therefore requires further attention by the submitter(s) if approval is still desired. Also, the cataloging that occurs at step 607 could contain a time stamped copy of the actual content of the feedback provided by the SISA center legal team, as well as the identity of the person in the legal team that performed the review, submitted the feedback and did not approve the clarification request form in its original state.

Upon the secure communication tracking and progress management tool forwarding the “not approved” clarification request form back to the submitter(s), a submitter or another person on the associated integration team again opens the clarification request form entry interface provided by the tool to enable them at step 608 to review and respond to the feedback provided by the SISA center legal team by revising the clarification request form. At this time, process 600 flows back to step 604 as indicated, where the secure communication tracking and progress management tool again automatically catalogs the subject clarification request form and assigns it to the SISA center's legal team for review. In this manner, process 600 can repeat this illustrated revision and feedback loop as many times as necessary until the clarification request form is determined by the SISA center's legal team to pass legal review and not raise any issues with respect to prohibited pre-merger collaboration. Additionally, each iteration of this loop would of course cause various entries within the request tracking database whenever steps 605 and 607 repeat, thus chronicling the evolution of the clarification request with time stamped database entries until its ultimate approval following step 605.

Once the clarification request form finally receives approval from the SISA center legal team after a review at step 605, the secure communication tracking and progress management tool proceeds with process 600 at step 609 by marking the clarification request as approved, automatically cataloging the approval of the form in the request tracking databases within the SISA center, and simultaneously communicating with the electronic network platform of the SISA management office (abbreviated as “SISA M.O.” in FIG. 6) so that a corresponding new record is created in the request tracking database (e.g., database 514a of FIG. 5) in the SISA management office's platform. It should be appreciated that step 609 thus represents the first communication of any information outside of the SISA center facility during process 600, and the cataloging of information in the request tracking database within the SISA management offices platform would entail the creation of a database entry showing only the current (approved by the SISA center's legal team) form of the clarification request (including identifying data, such as the assigned unique clarification request ID and the like), and preferably also information concerning when the request was forwarded to the SISA management office by SISA center legal team and exactly which SISA center person granted the final approval and when. Also, in the manner as described above, step 609 could include the secure communication tracking and progress management tool automatically notifying one or more members of the SISA management office's legal team regarding the “new” clarification request communicated out of the SISA center.

Next, at step 610, the legal team of the SISA management office would open the received clarification request form and perform a second level of legal review and approval for it. Similar in manner to the acts described above with respect to step 605, when the secure communication tracking and progress management tool forwards the clarification request form to the SISA management office's legal team, a member of that legal team opens the clarification request form using a reviewing interface provided by the SISA management office's corresponding secure communication tracking and progress management tool to initiate at step 610 the second and final level of legal review before the clarification request is communicated to one or more of the merging entities. The legal review interface of the SISA management office's secure communication tracking and progress management tool would likewise enable a legal team member to review the clarification request form, and either approve it (thus proceeding to step 613 as illustrated) or not approve it by entering feedback using the interface to the SISA center, such as in the form of comments, suggested revisions, questions, and the like at step 611. The submission of feedback at step 611 causes an automatic cataloging of the feedback (with time stamp and other identifying data) in the SISA management office's local request tracking database at 612, and then communicates that feedback back to the legal team of the SISA center by again updating the SISA center's request tracking database and forwarding the pending clarification request back to the SISA center legal team by returning process 600 to step 604 as illustrated. Understandably, steps 605 through 608 would again repeat as necessary until the clarification request is again approved by the SISA center's internal legal team as being suitable for communication outside of the SISA center.

If instead the subject clarification request form is approved after the review at step 610 by the SISA management office's legal team, this approval (with appropriate time stamping and metadata) is first cataloged in the request tracking databases of both the SISA center and SISA center management office at step 613 by the tool, and then routed by the tool electronically to the front end (e.g., element 521 of FIG. 5) for the appropriate pre-merger organization. The pre-merger organization receiving the clarification request can then use its front end at step 614 to route the clarification request to the appropriate recipients that will need to respond to the request, such as to an outside integration team working on related pre-merger planning issues, or to an appropriate business unit manager with the pre-merger organization. Process 600 thereafter concludes at step 615 with the designated recipient (e.g., the outside integration team), being delivered the final clarification request form, reviewing it, and beginning the compilation of a suitable reply.

In this manner, the tracking and cataloging process 600 in FIG. 6 monitors the progress of a clarification request at multiple levels through its various stages of creation within the SISA center, legal review, multiple subsequent rounds of revisions, and ultimate approval and communication to the intended recipient (i.e., an outside source of information, such as one of the merging entities). As illustrated above, at all times during process 600, the request tracking database within the SISA center monitors all activity with respect to a request, while the corresponding tracking databases maintained in the SISA management office's platform and by the pre-merger organization front end(s) only track and catalog clarification request activity that reaches its respective level of dissemination. The redundant levels of legal review permitted by process 600, as well as the multiple levels of status tracking using separate and independent request tracking databases, is an important feature of these embodiments of the invention as they provide high amounts of assurance that no information will leave the SISA center and be communicated to the merging organizations prior to deal approval/closing if that information could be interpreted or construed as being improper under the governing pre-merger anti-collaboration regulations.

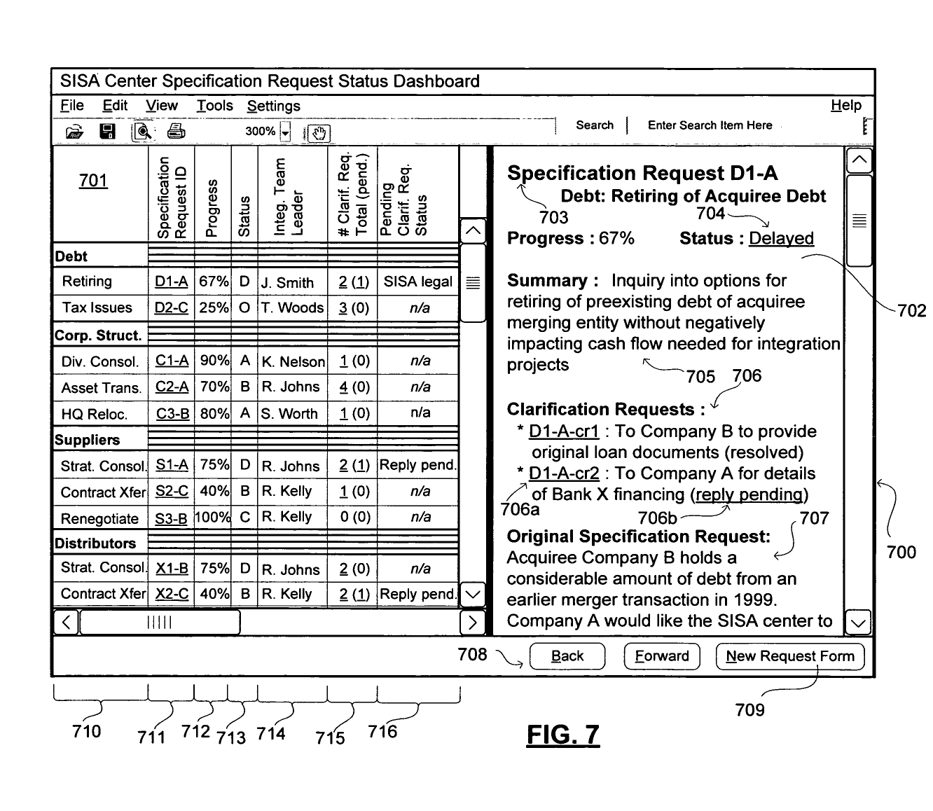

Referring now FIG. 7, there is depicted a view 700 of a suitable SISA center user interface provided by a secure communication tracking and progress management tool to an integration team member within the SISA center according to preferred embodiments of the present invention. The interface depicted in view 700 shows a “SISA Center Specification Request Status Dashboard,” which can be implemented using a web browser client and centrally located web server operated by the SISA center's network, to provide a relatively easy way for enabling a user to quickly browse, navigate, and drill down information contained with the various status and tracking databases in the SISA center in an intuitive manner, including, in particular, the status of various specification requests being worked on within the SISA center and of related clarification requests. Navigation window 701 provided by view 700 enables a user of the tool to utilize a common computer pointing device (e.g., a mouse) to browse through a hyperlinked table populated with various types of relevant information concerning all of the specification requests being handled by the SISA center, including information pertaining to the status of clarification requests associated with each specification request. A user can thereby browse, for example, by looking at different records for clarification requests according to identifying and/or descriptive information such as its associated specification requests, progress, status, and the like. Therefore, the table in navigation window 701 along a first side of the visual display provides a representative summary, or dashboard, regarding key progress information accumulated by the tool. This hyperlinked table in essence operates as a jumping-off point that users can use to navigate the various records automatically stored by the secure communication tracking and progress management tool into the request tracking databases and other databases within the SISA center network.

As depicted in FIG. 7, the dashboard table in navigation window 701 at its left most side includes various short titles 710 for the specification requests (e.g., “Debt: Retiring,” or “Suppliers: Contract Xfer”), which serve as row identifiers, and a plurality of information columns 711-716. In this manner, each row of the dashboard table contains information pertaining to a single specification request. The first column 711 of the dashboard table provides the unique specification request ID, which can follow any suitable consistent convention adopted by the SISA center. For example, as depicted, a three-digit code could be used where the first digit indicates a specification request category (e.g., “D” for debt, or “S” for suppliers), a second digit indicates its number within that category, and a third digit indicates from which entity the specification request originated (e.g., “A” denoting the acquirer, “B” the acquiree, or “C” for both). The second column 712 could show a progress indicator for the specification request, such as in the form of a percentage as shown. As noted above, this progress value can be created by a project management tool utilized with the SISA center so long as the values are stored in one of the databases accessible the secure communication tracking and progress management tool. A status signifier column 713 can show one of a select number of predefined codes that correspond to a status of the specification request. For example, status “A” could represent “ahead of schedule,” “B” could represent “behind schedule,” “C” could represent “completed,” “D” could represent “delayed,” and “O” could represent “on schedule.” Such a code is useful in that it provides the viewer, in conjunction with the progress value, with an immediate high level snapshot of where that specification request stands. For example, a project that has a progress value of only 25% but which is indicated as being “on time” may be less of a concern than one which has a progress value of over 50% but which is indicated as being “delayed” or “behind schedule.” Furthermore, a column 714 can be provided which indicates the integration team leader or some other contact person within the SISA center for the specification request in question.

The dashboard table in window 701 also contains information regarding the identification and status of clarification requests falling under or related to each specification request. As depicted, it is preferred that the dashboard table show a column 715 reporting the number of clarification requests relating to each specification request and, most preferably, also the number within that total that are currently pending in some form (i.e., not completed and answered by the intended recipient). Also, it is most preferred that a column 716 is included in the dashboard table that communicates a brief (e.g., one to two word) description regarding the status of any such pending clarification requests.

In navigation window 701 and display window 702, various portions of the text are illustrated as being underlined, which one skilled in the art of computer software design will recognize as a convention for showing an information hyperlink that can be selected by a clicking action in order to access related information. Thus, selection of a given hyperlink in the dashboard table displayed in navigation window 701, causes an appropriate corresponding type of information to be depicted in the display window 702 on the right side of the view. As depicted generally in the drawing, one or both of windows 701 and/or 702 can utilize scroll bars, zoom functions, and the like to help limit the size, appearance, and amount of information displayed in the view 700 in a conventional manner, and navigation buttons 709 (e.g., “Back” and “Forward”) to allow users to easily toggle among previously viewed records, files, and the like in the display window 702. The information depicted in display window 702 typically would of course vary depending upon how the user interacts with the hyperlinks of navigation window 701 or within the display window 702 itself.

In the specific view 700 depicted, a specification request summary is provided for the specification request having the assigned ID “D1-A” in the specification request database. By selecting the appropriate link in the specification ID column 711 of navigation window 701, the user is provided with a summary of all information available regarding the specification request in question, including the text/contents of the original request submitted to the SISA center, progress and status information on the specification request recorded by the SISA center personnel (such as with various electronic project management tools, such as Microsoft Project), and the content and status of any related clarification requests for the specification request in question. Thus, like selection of any of the other specification request IDs would cause similar types of information to be displayed in window 702.

The information displayed in window 702 preferably includes, as depicted, an initial title 703 at the top identifying the specification request in question, a measurement of progress 704 on the specification request (such as may be estimated by integration team leaders within the SISA center or determined by measurable metrics) and a status signifier 704. A summary 705 as depicted could also contain a short portion of text describing the particular specification request sufficiently to enable a user of the dashboard view to quickly navigate among various specification requests via window 701 to find a particular specification request of interest if it is not immediately identifiable solely from the brief descriptive information provided by the dashboard table displayed in navigation window 701. The specification request summary would also typically include one or more short abstracts 706 regarding each clarification request associated with the specification request in question. Each clarification request abstract 706 would preferably contain, as depicted, a hyperlink 706a to allow the user to view the complete overview file for the corresponding constraint minimization strategy in display window 702, and optionally contain links 706b to directly access the latest status information regarding a given clarification request. Finally, the specification request summary in display window 701 as depicted contains a section 707 showing the original and/or current wording of the specification request in full, and potentially provide links to any additional information supporting that request (such as electronic charts, graphs, document images, and the like). The user can thereby scroll down and review relevant portions of the clarification request summary and access status and event information concerning that request. Employing the interface to interact with the secure communication tracking and progress management tool in this manner, a user can thereby identify and explore any of the information contained in the various tracking and status databases of the SISA center network.

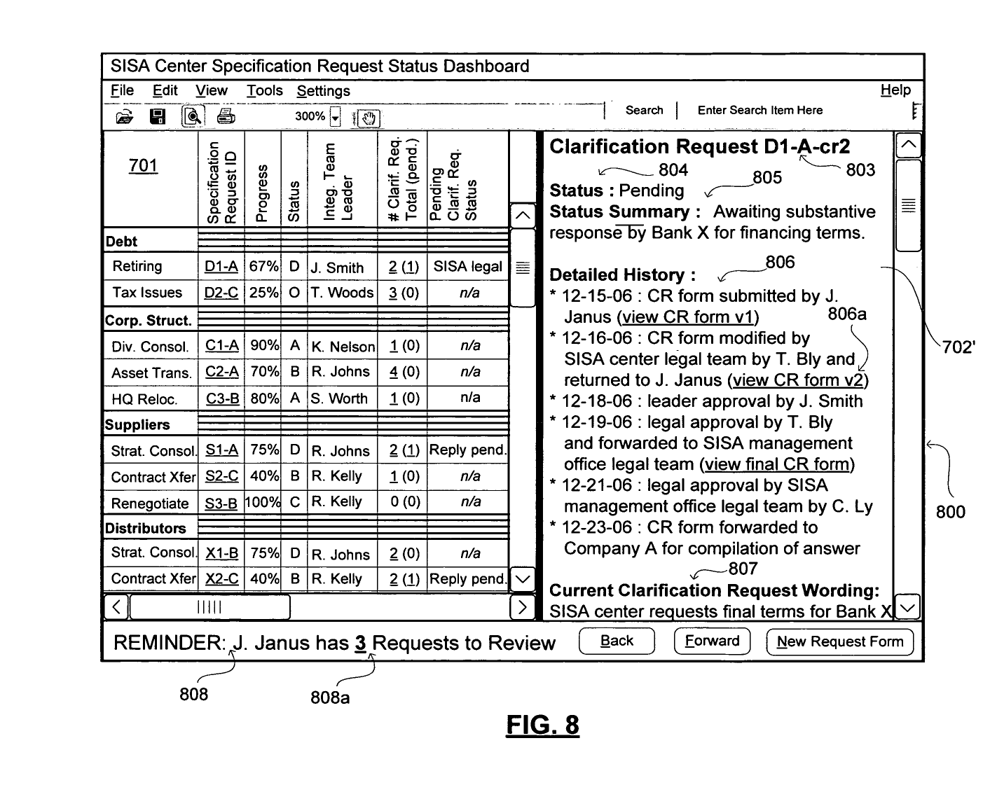

FIG. 8 shows a second view 800 of a SISA center user interface for a secure communication tracking and progress management tool according to preferred embodiments of the present invention, which view 800 may be displayed to a user when the user elects to review detailed information concerning a clarification request via the dashboard. A user could reach view 800 by, for example, selecting one of the hyperlinks 706a that pertains to the ID of a particular clarification request of interest (e.g., clarification request with the ID “D1-A-cr2”) or via a hyperlink embedded in the dashboard table of navigation window 701. As shown in FIG. 8, view 800 is substantially the same as previously described view 700 except that in display window 702′ a clarification request summary is displayed as opposed to the specification request summary. This clarification request summary appears in display window 702′ as a document containing various sections as depicted. There also can be hyperlinks embedded within this document for viewing additional related information or to navigate up or down to various sections of the document in conventional fashion. A clarification request summary can, as depicted in view 800, include, for example, a heading section showing a title 803 for the clarification request as well as the current status category 804 (e.g., pending response, in draft, awaiting legal approval, etc.), and, optionally, a short statement 805 summarizing the current status 804. Most notably, the clarification request summary document depicted in window 701′ includes a detailed history 806 showing in chronological order the various dated events that mark the evolution of the clarification request in question within the SISA center's request tracking database. As shown, this detailed history can show when legal review starts, when approvals or rejections occur, etc., and also which user actually performed each action. Understandably, the views 700 and 800 of FIG. 7 and FIG. 8 depict the interface as it would be seen by a user that is a member of the SISA center personnel. Different levels of detail would be provided to users that are personnel of the SISA management office as the secure communication tracking and progress management tool would only use information culled from the SISA management office's local request tracking database to provide information regarding the specification/clarification requests. Thus, for example, any information screened out from draft clarification requests would not be visible by such a user via a corresponding SISA management office dashboard.

Furthermore, various hyperlinks 806a can be provided within this section following certain notable event bullet points which hyperlinks 806a can each be selected by the user to view (such as in a pop-up window) the state of the specification request (or feedback from legal) saved by the secure communication tracking and progress management tool at that time in association with the event for that bullet. Finally, the clarification request summary in display window 701′ as depicted contains a section 807 showing the current wording of the clarification request in full. The user can thereby scroll down and review relevant portions of the clarification request summary and access various status and event information concerning that request.

Also, it should be noted that view 800 is depicted as showing a pending request alert 808 at the bottom of the screen that shows the current logged in user (e.g., “J. Janus”) that they have one or more clarification requests that require their attention (whether as, as in the case depicted, the submitter or as a designated legal reviewer). This alert 808 could likewise comprise a hyperlink 808a that would, upon user selection via a click, open a window with the appropriate request review/revision/approval form (depending upon the role of the user). Likewise, if the user is the designated submitter and action is required, the clarification request summary displayed would be altered automatically to show the action necessary (e.g., displaying the revisions suggested by legal) and enabling the user to open and modify the request as desired.

In this manner, a user of tools according to the present invention is provided with a substantially simplified way to navigate the tracking, status, and progress information cataloged and made available by the secure communication tracking and progress management tool and other tools of the SISA center network.

Referring back to FIG. 7, it can be seen that the views 700 and 800 of the Status Dashboard (when the user is a potential submitter, such as an integration team member) as depicted contain a button 709 to allow the user to launch a new clarification request form. Turning now to FIG. 9, there is depicted a third view 900 of a suitable user SISA center interface to the a secure communication tracking and progress management tool showing the form that may be used to create clarification requests according to preferred embodiments of the present invention. Generally, it can be seen that this form provides both open ended questions and questions having drop down menu selectable answers (such as is illustrated by menu 911 being depicted as actively selected by the user's cursor in FIG. 9) intended to make the requester enter sufficient data to both fully describe their new (or modified) request to facilitate legal review by the SISA management office, and to enable the tool to create associations and populate required fields within the various tracking databases.

The top of the form contains a title bar 901 showing the status of the form/request (e.g., new and unsaved), and starts with two fields that are auto-populated by the secure communication tracking and progress management tool. In particular, a field for the version 902 of the clarification request and a field for the creator 903 of the form cannot be changed by the user. The first field that can be modified by the user comprises a drop down menu 904 for the user to select an owner for the clarification request. Thus, it is possible for one person to fill out the clarification request form on behalf of another person within the SISA center (such as an integration team leader or information lead). Another drop down menu 905 is provided enabling the user to specify the SISA center integration team associated with the request, and text entry boxes 906 are supplied for the user to specify a date by which a response is needed or desired. The next input field is a text entry box 907 that asks the user to specify a short title for the new clarification request.

As shown in FIG. 9, the form next provides the user with the ability to specify one or more specification requests to which this new clarification request is related. In particular, a first drop down menu 908 is provide for the user to enter the identification of a primary specification request, and a second drop down menu 909 allows the user optionally to add a secondary specification request (e.g., a cross-reference). A button 910 is also provided on the form enabling the user to specify more than one secondary specification request reference.

Two drop menus 911 and 912 are next provided for the user to select a primary intended recipient for the clarification request and an optional secondary intended recipient, respectively. Similar to with the specification request cross references, a button 913 is provided enabling the user to potentially add additional secondary recipients for the new clarification request.

Finally, the clarification request form depicted in view 900 concludes with a large text box 914 instructing the user to type in a detailed description of the clarification request. It should be understood that this field would entail the primary portion of the clarification request and would be the portion of the request that is carefully scrutinized by the SISA center's and SISA management office's legal teams before approving the request.

Various buttons are also provided at the bottom of the displayed view 900, which permits the user to save a draft of the clarification request and exit (button 915), or to exit and discard changes (button 916). Another button permits the user to save the document as a new version (i.e., the version 902 automatically assigned by the tool) once he or she is satisfied that it should be submitted for legal review (button 917).

Additionally, a button 918 is indicated in broken lines in FIG. 9. This is intended to represent that that particular button is not present in the view of every user, but rather only for those users that are noted by the tool as having approval permissions (e.g., lawyers on the SISA center team). It should be understood, therefore, that the views provided to different users within the SISA center would be slightly different, but still follow the general form shown in FIG. 9. For example, a lawyer on the SISA review team might receive and review a new clarification request via a view similar to view 900, but be provided with an additional text field to submit questions, comments, or other remarks to accompany rejections, or be able to modify the original text description submitted by the user to omit objectionable material and then have the modified form sent back to the submitter for review and approval, and revision and resubmission.

Various processes of the methods described herein may be implemented using software stored in the memory of a computing device for execution by suitable processors. Alternatively, the mobile devices and/or servers may implement such processes and methods in hardware or a combination of software and hardware, including any number of processors independently executing various programs and dedicated hardware, such as application specific integrated circuits (ASICs), field programmable gate arrays (FPGAs), and the like.

As will be readily understood by one of ordinary skill in the art, the above schematic diagrams and flow charts are meant to be illustrative of preferred operation of the secure information sharing architecture and the related platforms, tools and methods that are utilized to enable and support the architecture according to the present invention. Thus, the particular elements of the illustrated embodiments, including the number, ordering and relationship of the various steps, could be modified in various insubstantial ways while still providing tools and processes according to the present invention.

The foregoing description of the preferred embodiments of the invention has been presented for the purposes of illustration and description. It is not intended to be exhaustive or to limit the invention to the precise form disclosed. Many modifications and variations are possible in light of the above teaching. It is therefore intended that the scope of the invention be limited not by this detailed description, but rather by the claims appended hereto.

1. A computing network architecture adapted to facilitate the tracking and cataloging of communications within a secure information sharing architecture (“SISA”) adapted to facilitate post-merger integration planning tasks for a merger involving one or more merging entities during a regulatory review period, said computing network architecture comprising:
a secure communication tracking and progress management tool adapted to permit users create, track and monitor requests for information, said tool comprising a first component and a second component that are adapted to communicate securely with one another;
a secure information facility network located within a SISA center facility, said secure information facility network comprising first computing means supporting said first component of said tool and a first request tracking database; and
a SISA management office network located external to said SISA center facility and in electronic communication with said secure information facility network, said SISA management office network comprising second computing means supporting said second component of said tool and a second request tracking database;
wherein said tool is operable to permit users located within said SISA center to ask clarification questions to persons associated with said merging entities via clarification requests prepared and submitted using forms of said tool, wherein said clarification requests once submitted are automatically cataloged and routed by said tool through at least two levels of legal review, and wherein said first level of legal review occurs at said first component and is cataloged in said first request tracking database and said second level of legal review occurs at said second component and is cataloged in both said first and second request tracking databases.

2. The computing network architecture according to claim 1, further comprising at least one pre-merger organization front end in secure remote electronic communication with said second component, said front end being in local communication with a third request tracking database and adapted to electronically receive clarification requests from said first component via said second component following approvals granted at both said levels of legal review.

3. The computing network architecture according to claim 2, wherein said front end automatically catalogs in said third request tracking database all clarification requests received by said front end from said second component, and automatically catalogs in said third request tracking database all replies to said clarification requests sent to said second component.

4. The computing network architecture according to claim 3, wherein said replies are cataloged in said first and second request tracking databases.

5. The computing network architecture according to claim 1, wherein said second component is adapted to route said clarification requests automatically among appropriate members personnel of said SISA management office to ensure that it is handled according to a secure information handling procedures, said personnel including legal professionals and said procedures including anti-collaboration legal review by said legal professions.

6. The computing network architecture according to claim 1, wherein said cataloging of information in a given one of said request tracking databases comprises creating a database entry recording a current state of a particular clarification request, identifying data regarding said particular clarification request, a description of any current activities concerning said particular clarification request, and an identification of any users performing said current activities.

7. The computing network architecture according to claim 1, wherein said SISA management office electronic network further has interface to permit personnel of said SISA management office to review, create, and process specification requests, said specification requests regarding tasks for consideration by specialists quarantined within said SISA center facility.

8. The computing network architecture according to claim 1, wherein said second component is in secure electronic communication with a pre-merger organization front end accessible by at least of said merging entities.

9. The computing network architecture according to claim 8, wherein said front end receives a particular clarification request only after it is approved at both of said first and second levels of legal review.

10. The network architecture according to claim 9, wherein said front end enables at least one of said merging entities to submit specification requests to said SISA center facility via said tool, said specification requests comprising post merger integration research and planning directives originating from leaders of said at least one of said merging entities.

11. The network architecture according to claim 10, wherein said components and front ends provide interfaces adapted to provide tracking and status update information concerning said tasks and said clarification requests.

12. The computing network architecture according to claim 1, wherein said first level of legal review is triggered by an automated routing of a submitted clarification request to a first legal interface of said first component, and wherein said first legal interface is adapted to be usable by legal professional users quarantined within said SISA center facility.

13. The computing network architecture according to claim 12, wherein said second level of legal review is triggered by an automated routing of said submitted clarification request after it is approved by said legal professional users to said second legal interface where it must be approved by second legal professionals located outside of said SISA center facility.

14. A computing network architecture adapted to facilitate the tracking and cataloging of communications within a secure information sharing architecture (“SISA”) adapted to facilitate post-merger integration planning tasks for a merger involving one or more merging entities during a regulatory review period, said computing network architecture comprising:
a secure communication tracking and progress management tool adapted to permit users create, track and monitor requests for information, said tool comprising a first component and a second component that are adapted to communicate securely with one another;
a secure information facility network located within a SISA center facility, said secure information facility network comprising first computing means supporting said first component of said tool and a first request tracking database, and said first component provides a request interface and a first legal review interface to users located within said SISA center facility, said request interface being adapted to allow users within said SISA center to ask clarification questions to persons associated with said merging entities by creating clarification requests prepared and submitted with forms of said tool; and
a SISA management office network located external to said SISA center facility and in electronic communication with said secure information facility network, said SISA management office network comprising second computing means supporting said second component of said tool and a second request tracking database, and said second component provides a second legal review interface to users located within said SISA center facility;
wherein said clarification requests once submitted are automatically cataloged and routed by said tool through at least two levels of legal review, wherein said first level of legal review is triggered by an automated routing of a submitted clarification request to said first legal interface where it must be approved by legal professional users quarantined within said SISA center facility, and said second level of legal review is triggered by an automated routing of said submitted clarification request after it is approved by said legal professional users to said second legal interface where it must be approved by second legal professionals located outside of said SISA center facility, and wherein any activities impacting said clarification request at each level of legal review are cataloged in particular ones of said request tracking databases depending upon from which of said interfaces said activities originate.

15. The computing network architecture according to claim 14, wherein said activities comprise an approval or rejection of a submitted clarification request by said first legal professionals, and wherein said tool automatically catalogs details regarding said approval or rejection in said first request tracking database.

16. The computing network architecture according to claim 15, wherein a particular clarification request has been previously approved by said first legal professionals, and wherein said activities comprise a secondary level approval or rejection of said particular clarification request by said second legal professionals, and wherein said tool automatically catalogs details regarding said secondary level approval or rejection in both said first and second request tracking databases.

17. The computing network architecture according to claim 16, wherein said first level of legal review is controlled by said first component and is cataloged in said first request tracking database, and said second level of legal review is controlled by said second component and is cataloged in both said first and second request tracking database.

18. The computing network architecture according to claim 14, further comprising at least one pre-merger organization front end in secure remote electronic communication with said second component, said front end being in local communication with a third request tracking database and adapted to electronically receive clarification requests from said first component via said second component following approvals granted at both said levels of legal review.

19. The computing network architecture according to claim 18, wherein said front end automatically catalogs in said third request tracking database all clarification requests received by said front end from said second component, and automatically catalogs in said third request tracking database all replies to said clarification requests sent to said second component.

20. The computing network architecture according to claim 19, wherein said replies are cataloged in said first and second request tracking databases.

21. The computing network architecture according to claim 14, wherein said cataloging of information in a given one of said request tracking databases comprises creating a database entry recording a current state of a particular clarification request, identifying data regarding said particular clarification request, a description of any current activities concerning said particular clarification request, and an identification of any users performing said current activities.

22. The computing network architecture according to claim 14, wherein said SISA management office electronic network further has a management interface to permit personnel of said SISA management office to review, create, and process specification requests, said specification requests being strategic directives regarding said tasks for consideration by specialists quarantined within said SISA center facility.

23. A secure communication process for supporting the performance of post-merger integration planning tasks within a secure information sharing architecture (“SISA”) for a merger involving one or more merging entities during a regulatory review period, said process comprising:
establishing a secure information facility network located within a SISA center facility, said secure information facility network comprising first computing means and a first request tracking database;
establishing a SISA management office network located external to said SISA center facility and in electronic communication with said secure information facility network, said SISA management office network comprising second computing means and a second request tracking database;
loading a first component of a secure communication tracking and progress management tool on said first computing means and a second component of said tool on said second computing means, each of said components being adapted to communicate securely with one another to permit users within a respective network to create, track and monitor requests for information; and
operating the tool, wherein said tool is operated by users located within said SISA center to ask clarification questions to persons associated with said merging entities via clarification requests prepared and submitted using forms of said tool, wherein said clarification requests once submitted are automatically cataloged and routed by said tool through at least two levels of legal review, and wherein said first level of legal review occurs at said first component and is cataloged in said first request tracking database and said second level of legal review occurs at said second component and is cataloged in both said first and second request tracking databases.

24. The process according to claim 23, further comprising receiving a response to a given clarification request from a pre-merger organization front end in remote electronic communication with said second component, said pre-merger organization front end being associated with at least one of said merging entities and in local communication with a third request database.

25. The process according to claim 24, wherein said response from said pre-merger organization front end is subjected to said two levels of legal review prior to said response being routed to a submitter of said given clarification request.

26. The process according to claim 24, further comprising providing tracking and status update information concerning past specification requests and clarification requests via said front end.

27. The process according to claim 23, further comprising establishing at least one pre-merger organization front end in secure remote electronic communication with said second component, said front end being in local communication with a third request tracking database and adapted to electronically receive clarification requests from said first component via said second component following approvals granted at both said levels of legal review.

28. The process according to claim 27, wherein said front end automatically catalogs in said third request tracking database all clarification requests received by said front end from said second component, and automatically catalogs in said third request tracking database all replies to said clarification requests sent to said second component.

29. The process according to claim 28, further comprising cataloging said replies in said first and second request tracking databases.

30. The process according to claim 23, wherein said second component is adapted to route said clarification requests automatically among appropriate members personnel of said SISA management office to ensure that it is handled according to a secure information handling procedures, said personnel including legal professionals and said procedures including anti-collaboration legal review by said legal professions.

31. The process according to claim 23, wherein said first level of legal review is triggered by an automated routing of a submitted clarification request to a first legal interface of said first component, and wherein said first legal interface is adapted to be usable by legal professional users quarantined within said SISA center facility.

32. The process according to claim 31, wherein said second level of legal review is triggered by an automated routing of said submitted clarification request after it is approved by said legal professional users to said second legal interface where it must be approved by second legal professionals located outside of said SISA center facility.
